(19) United States
(12) Patent Application Publication
(10) Pub. No.: US 2013/0076800 A1
(43) Pub. Date: Mar. 28, 2013

(54) SCANNING PROJECTION APPARATUS AND SCANNING IMAGE DISPLAY

(71) Applicants: Michio HATAGI, Chigasaki (JP); Takeshi Nakao, Sagamihara (JP); Tomoto Kawamura, Yokohama (JP); Kunikazu Ohnishi, Yokosuka (JP); Hiromi Kita, Hiratsuka (JP)

(72) Inventors: Michio HATAGI, Chigasaki (JP); Takeshi Nakao, Sagamihara (JP); Tomoto Kawamura, Yokohama (JP); Kunikazu Ohnishi, Yokosuka (JP); Hiromi Kita, Hiratsuka (JP)

(21) Appl. No.: 13/552,682

(22) Filed: Jul. 19, 2012

(30) Foreign Application Priority Data
Sep. 28, 2011 (JP) JP-2011-211876
Sep. 28, 2011 (JP) JP-2011-211877
Oct. 5, 2011 (JP) JP-2011-220625
Oct. 21, 2011 (JP) JP-2011-231258
Nov. 30, 2011 (JP) JP-2011-261926

(51) Int. Cl. G03B 21/28; G09G 5/10

(52) U.S. Cl. 345/690; 353/37; 353/31; 353/20

(57) ABSTRACT

In a light beam scanning projection apparatus which scans a light beam emitted from a laser light source, an image display apparatus is configured including a plurality of light beams, a reflection mirror for reflecting the light beams to project them onto a screen or the like, and a mirror driving unit for driving the reflection mirror so that the plurality of light beams are incident on the reflection mirror with different optical axes and projected on different projection areas, thereby displaying a single image with a plurality of images. Further, by forming a single image by causing a plurality of the light beams to have predetermined relative angles thereamong so as to make a plurality of images overlap on each other with slight shifts, a scanning projection apparatus is provided with which the luminance of the image is improved while conforming to safety standards.

### INCORPORATION BY REFERENCE

The present application claims priorities from Japanese applications JP-2011-211876 filed on Sep. 28, 2011, JP-2011-211877 filed on Sep. 28, 2011, JP-2011-220625 filed on Oct. 5, 2011, JP-2011-231258 filed on Oct. 21, 2011, and JP-2011-261926 filed on Nov. 30, 2011, the contents of which are hereby incorporated by reference into this application.

### BACKGROUND OF THE INVENTION

The present invention relates to a scanning projection apparatus and a scanning image display and, more particularly, to an optical apparatus for displaying by projection an image on, for example, a predetermined projection screen by scanning a light beam two-dimensionally by a predetermined optical beam deflection means.

In recent years, various kinds of scanning projection apparatuses or scanning image displays have been proposed which are equipped with functions of scanning a light beam two-dimensionally on a predetermined projection screen by projecting the light beam emitted from a predetermined light source onto the predetermined screen and deflecting the light beam two-dimensionally by a predetermined deflection means, and of displaying by projection a two-dimensional image with the afterimage effect on the screen.

A specific example of such a scanning image display is disclosed in JPA-2006-178346, for instance.

In this type of scanning image displays, higher luminance is pursued but, when a laser is used as the light source of the light beam, the upper limit of the amount of light entering an eye is provided from a viewpoint of safety standards intended for eye protection.

For example, as a means for implementing higher luminance there is a method of achieving it by forming a plurality of images using a plurality of laser light sources, and in such a case measures to prevent a plurality of the light beams from simultaneously entering an eye are indispensable.

As an example of a scanning projection apparatus for achieving the higher luminance, in U.S. Pat. No. 7,002,716, U.S. Pat. No. 6,762,867, and U.S. Pat. No. 6,803,561 a scheme is proposed which reconciles the higher luminance with compatibility to the safety standards by irradiating deflection scanning elements such as MEMS (Micro Electro-Mechanical Systems) mirrors with a plurality of light beams with relative angles therebetween and forming a plurality of images to arrange in a row.

### SUMMARY OF THE INVENTION

Incidentally, in order to increase brightness (luminance) of an image displayed by projection on the projection screen or the like in the scanning image display disclosed in JP-A-2006-178346, such a method can be considered as a simple method that the output intensity of a light beam for image display scanned two-dimensionally on the projection screen is simply increased, for example.

In the method of simply increasing the intensity of a single light beam for image display like this, however, the light source has a limit in the brightness (luminance) of an image able to be increased due to restrictions imposed on the output performance of light source and the like and the brightness (luminance) cannot be increased without limitation.

Further, the method of increasing the intensity of a single light beam for image display has danger of arising such a serious problem in safety that, if the light beam enters into a human eye accidentally, a serious accident such as loss of sight would result.

In order to form a plurality of images by causing a plurality of light beams to enter deflection scan elements as disclosed in the above-described publicly known examples, it is indispensable that the relative angles between plural incident light beams which conform to the safety standards need to be equal to or greater than a certain value. In U.S. Pat. No. 7,002,716, U.S. Pat. No. 6,762,867, and U.S. Pat. No. 6,803,561, four images, for example, are partly overlapped with each other to construct a image of approximately four times in size. However, increase of the relative angles between the images cause differences in image shapes owing to scanning distortions among the plural images, thus giving rise to a problem that composition of the images is difficult to achieve. In addition, since the plurality of images are so arranged as to be partly overlapped, improvement in luminance and enlargement of the images take place concurrently and the scanning distortion concomitant with the image enlargement becomes complicated.

The scanning distortion referred to herein represents a phenomenon in which, when a light beam is scanned two-dimensionally using a reflection-type optical beam deflection scanning element or device, due to combination of a scan angle in the horizontal direction and a scan angle in the vertical direction, a deviation is generated with respect to ideal scan lines on the projection screen, with the result that a large image distortion takes place in a two-dimensional image projected on the screen.

With the above situation in mind, with the present invention, a scanning projection apparatus and a scanning image display are provided which can increase the brightness (luminance) of the projected image favorably without resort to increase of intensity of the individual scan light beam while favorably avoiding the above safety problem. Also, with the present invention a scanning projection apparatus and a scanning image display are provided in which relative angles of a plurality of incident light beams are maintained to be the lowest necessary for conforming to the safety standards.

The above objectives can be accomplished by the inventions recited in the scope of appended claims.

The present invention can provide a scanning projection apparatus and a scanning image display which can project brighter images than those by the conventional apparatuses with a simple construction while satisfying the safety standards.

Other objects, features, and advantages of the invention will become apparent from the following description of the embodiments of the invention taken in conjunction with the accompanying drawings.

### BRIEF DESCRIPTION OF THE DRAWINGS

FIG. 1 is a configuration diagram of a scanning projection apparatus 100 in Embodiment 1;

FIG. 2 is a detail plan of an RGB (Red, Green, and Blue) light source 101 in Embodiment 1;

FIG. 3 is a detail plan of a modified example of the RGB light source in Embodiment 1;

FIG. 4 is a configuration diagram of a scanning projection apparatus 400 in Embodiment 2;

FIG. 5 is a detail view of an optical refraction element 103 in Embodiment 2;

FIG. 6 is a block diagram of a scanning image display in Embodiment 4;

FIG. 7 is a detail plan of another example 103b of the optical refraction element 103 in Embodiment 2;

FIG. 8 is a detail plan of yet another example 103c of the optical refraction element 103 in Embodiment 2;

FIG. 9 is a configuration diagram of a scanning image display 500 in Embodiment 3;

FIG. 10 is a detail plan of an optical beam combiner 108 in Embodiment 3;

FIG. 11 is a detail plan of another example 108b of the optical beam combiner 108 in Embodiment 3;

FIG. 12 is a detail plan of yet another example 108c of the optical beam combiner 108 in Embodiment 3;

FIG. 13 is a detail plan of another example 300b of the RGB light source 300 in Embodiments 1, 2, and 3;

FIG. 14 is a detail plan of yet another example 300c of the RGB light source 300 in Embodiments 1, 2, and 3;

FIG. 15 is a diagram showing a first modification of a two-beam combining method in Embodiment 5;

FIG. 16 is a diagram showing a second modification of the two-beam combining method in Embodiment 5;

FIG. 17 is a diagram showing a third modification of the two-beam combining method in Embodiment 5;

FIG. 18 is a diagram showing a fourth modification of the two-beam combining method in Embodiment 5;

FIG. 19 is a diagram showing a fifth modification of the two-beam combining method in Embodiment 5;

FIG. 20 is a diagram showing a sixth modification of the two-beam combining method in Embodiment 5;

FIG. 21 is a schematic side view of a scanning projection apparatus in Embodiment 6;

FIG. 22 is a schematic front view illustrating an effective area of an image displayed by projection on a screen of the scanning projection apparatus in Embodiment 6;

FIG. 23 is a schematic side view and a ray diagram illustrating details of an example of an optical element for light beam composition used in the scanning projection apparatus in Embodiment 6; and

FIG. 24 is a diagram to explain an optical function and an effect of the optical element for light beam composition in Embodiment 6.

### DESCRIPTION OF THE EMBODIMENTS

Hereinafter, description is given in details by way of embodiments shown in the accompanying drawings but this in no way limits optical constructions of the present invention.

### Embodiment 1

Embodiment 1 of the present invention is described using drawings.

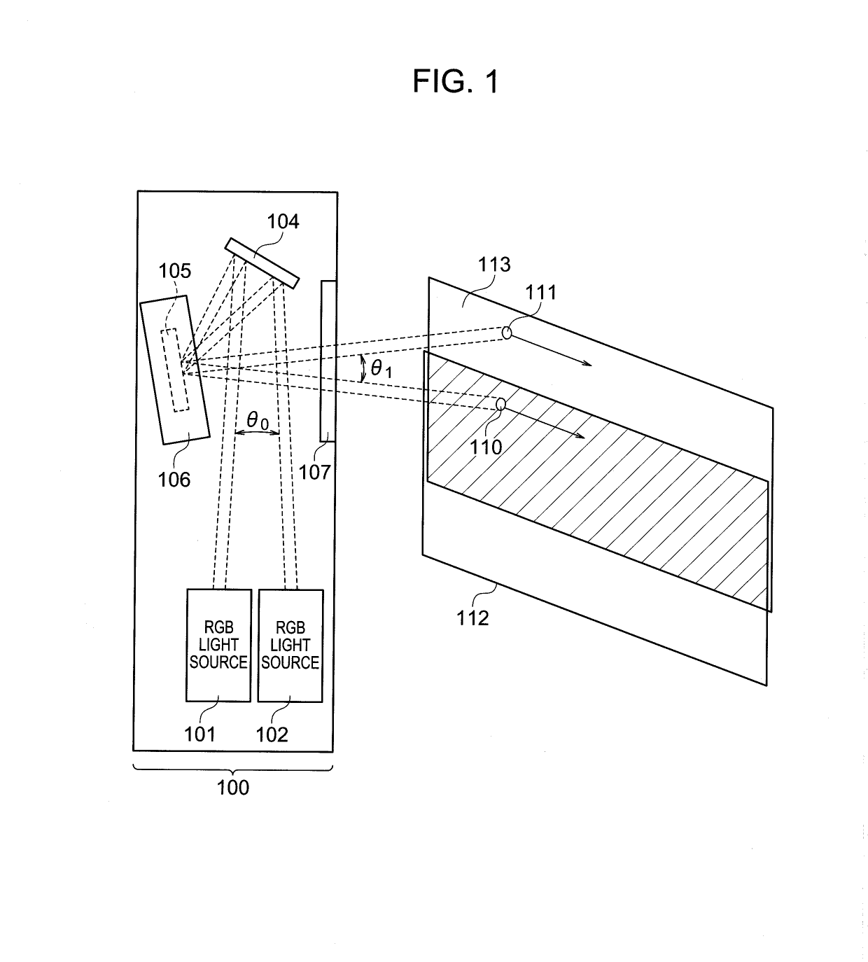

FIG. 1 is an explanation drawing of a scanning projection apparatus 100 of Embodiment 1 according to the present invention. In the figure, optical beam diameters are indicated with dotted lines. Incidentally, the optical beam diameter refers to a diameter at which the intensity in the light beam becomes 1/exp(2) of the intensity on the optical axis.

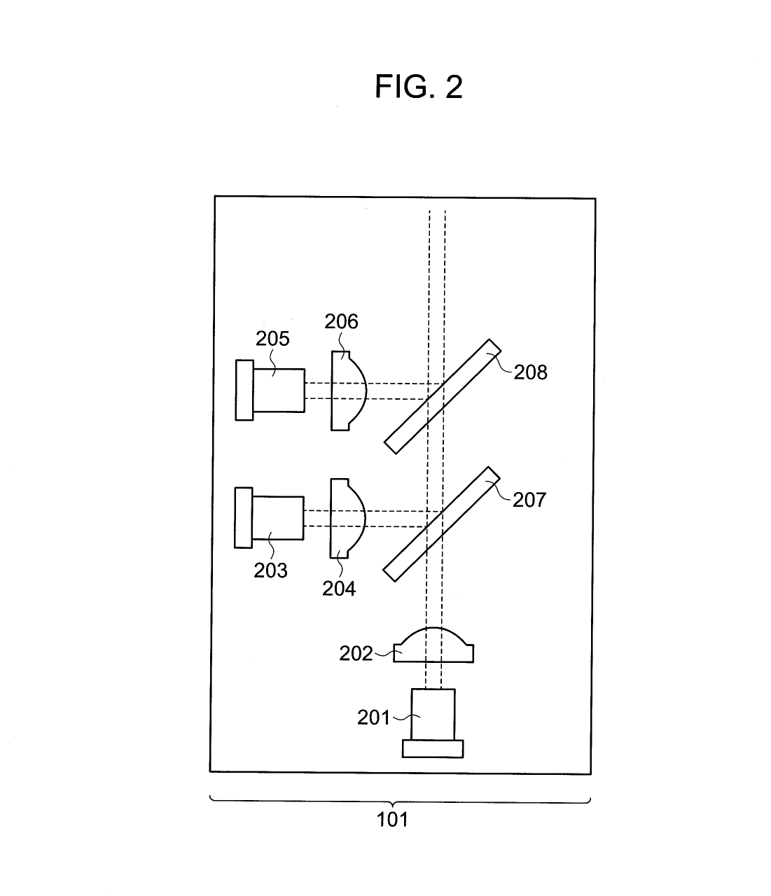

FIG. 2 is a detail plan of an RGB light source 101 in FIG. 1. The RGB light source referred to herein is a light source for composing three primary colors of red, green, and blue necessary for image display. In the figure, dotted lines designate optical beam diameters of light beams.

A laser light source 201 is a laser diode which emits a green light beam of, for example, 520 nm band. The green light beam emitted from the laser light source 201 is converted to a collimated light beam or a slightly converged light beam by a collimating lens 202. Incidentally, the laser light source 201 may be a so-called SHG optical source using a so-called second harmonic wavelength.

A laser light source 203 is a laser diode which emits a red light beam of, for example, 640 nm band. The red light beam emitted from the laser light source 203 is converted to a collimated light beam or a slightly converged light beam by a collimating lens 204.

A laser light source 205 is a laser diode which emits a blue light beam of, for example, 455 nm band. The blue light beam emitted from the laser light source 205 is converted to a collimated light beam or a slightly converged light beam by a collimating lens 206.

An optical beam combiner 207 is a dichroic mirror which transmits the green light beam and reflects the red light beam. Further, it is adjusted so that the optical axes of the green light beam and the red light beam approximately coincide with each other.

An optical beam combiner 208 is a dichroic mirror which has a function of transmitting the green light beam and the red light beam and reflecting the blue light beam. It is adjusted so that the optical axis of the blue light beam and that of the green and red light beam approximately coincide with each other.

An RGB light source 102 has the identical configuration to the RGB light source 101. In FIG. 1, the RGB light sources 101 and 102 are so arranged that a relative angle between two light beams emitted therefrom is θ₀. The relative angle θ₀ will be described later in detail.

The two light beams of three colors from the RGB light sources 101 and 102 emitted at the relative angle θ₀ are reflected by a total reflection mirror 104 and, then, enter a scan element 106.

The scan element 106 is configured with a scan mirror 105 and a driving electrode or the like (not shown) for driving the scan mirror 105. The scan mirror 105 has a horizontal scan axis and a vertical scan axis and it functions to scan the light beam two-dimensionally on a screen by driving in deflection the scan mirror 105 about the respective scan axes. The scan mirror 105 can be implemented using, for example, a Micro Electro Mechanical Systems (hereinafter referred to as MEMS) mirror, a galvano-mirror, or the like. It should be noted that the scan element 106 may also be constituted by two scan mirrors, with the first scan mirror having a vertical scan axis and with the second scan mirror having a horizontal scan axis.

Incidentally, it is preferable that the two light beams of three colors have their optical beam diameters coincident with each other on the scan mirror 105. This is because the scan mirror 105 is driven at a high speed in nature and, therefore, an area on which the two light beams of three colors reflect needs to be as small as possible on the surface of the scan mirror, which is the driven part. Besides, in the case the scan element 106 is comprised of two scan mirrors, the two optical beam diameters are preferably made coincident with each other on one of the two scan mirrors which has the narrower reflection effective area.

The relative angle θ₀ is set to an angle for making the two light beams of three colors coincident with each other on the scan mirror 105. Of course, when the scan element 106 is comprised of two scan mirrors, it is needless to say that it is set to an angle for making the two beams coincident with each other on a scan mirror which is narrower in the reflection effective area out of two.

The two light beams of three colors exiting from the scan element 106 are incident on a transparent cover 107 provided on the interface of the scanning projection apparatus 100 with the outside. The transparent cover 107 is presumed to be a transparent glass or a plastic cover having a sufficiently high transmittance for the light beams of three colors and with the transparent cover provided, it is possible to prevent transmittances of optical components from deteriorating, to prevent the scan element 106 from failing, or the like due to dusts and the like entering the scanning projection apparatus 100.

The two light beams of three colors passing through the transparent cover 107 form light spots 110 and 111, respectively, on a screen installed outside. At that time, a relative angle between the two light beams is θ₁. In the present embodiment, the relative angle θ₀ and the relative angle θ₁ are identical. However, in case an optical element based on refraction or diffraction is inserted or the like in the optical paths from the RGB light sources 101 and 102 to the transparent cover 107, the relative angle θ₀ and the relative angle θ₁ may not coincide with each other. In any case, the relative angle θ₁ is a function of the relative angle θ₀ and the relative angle θ₁ is an angle determined by setting the relative angle θ₀.

Since the relative angle θ₁ has a correlation to a difference in the scanning distortion of the image between two images 112 and 113, the relative angle θ₁ is preferably as small as possible when composition of the two images is taken into consideration; in the present invention a necessarily minimal angle conforming to the eye safety standards is defined as the relative angle θ₁. Details of the relative angle θ₁ is described later.

The scanning distortion referred to herein represents a phenomenon in which, when a light beam is scanned two-dimensionally using a reflection-type optical beam deflection scanning element or device, due to combination of a scan angle in the horizontal direction and a scan angle in the vertical direction, a deviation is generated with respect to ideal scan lines on the projection screen, with the result that a large image distortion takes place in a two-dimensional image projected on the screen.

The two light spots 110 and 111 formed on the screen are scanned in the horizontal direction and the vertical direction by the scan element 106 to form respective images. In a part where the two formed images 112 and 113 overlap, a brightness of approximately twice of an ordinary image can be realized.

The relative angle θ₁ is described previously as a necessarily minimal angle conforming to the eye safety standards and is hereinafter described in details. Japanese Industrial Standard “Safety of Laser Products” (Japanese Industrial Standards C6802-2005) provides Classes of laser output and, for general sale pursuant to “Consumer Products Safety Act” in Japan, a product must be of Class 2 or less to be sold in general.

A laser measurement condition for Class decision are provided that, in the case of a laser scanning apparatus, the optical energy incident on an area of 7 mm diameter corresponding to a pupil of a human eye at a position of 100 mm away from a light source is to be a predetermined value or less. When two light beams are considered, for example, a condition for inhibiting the two light beams from being incident simultaneously on the area of 7 mm diameter is that the relative angle between the two light beams is 4° or more. In the present invention, this relative angle is defined as θ₁. By taking various optical elements and accuracy of setting up the two beams into consideration, the relative angle θ₁ is preferably about 5° or more.

On the other hand, as the relative angle θ₁ increases, the overlapped portion of the images indicated in the shaded in FIG. 1 decreases. Since it is an overlapping portion of images where the brightness of the image increases, in order to obtain an image area of as high brightness as possible, the aforementioned relative angle is preferably set to an angle at which a plurality of images overlap with each other by more than ½. The angle at which a plurality of images overlap with each other by more than ½ differs depending on the scan angle of the scan mirror 105, the image size on the screen, or the like.

The scanning projection apparatus 100 according to the present embodiment may be configured at least with the laser light source 201 and the collimating lens 202, the laser light source 203 and the collimating lens 204, the laser light source 205 and the collimating lens 206, the optical beam combiners 207 and 208, the scan element 106, and the transparent cover 107; it may have additional optical elements on the way such as an optical grating and a waveplate or it may take a configuration with the optical path being bent with, for example, the total reflection mirror 104. Further, an optical element having a function to change the scan angle of the scan element 106 or the like may be added in an optical path between the transparent cover 107 and the scan element 106.

Incidentally, in the present embodiment, the optical axes of the light beams of three colors, green, red, and blue, are combined by the optical beam combiners 207 and 208, which are dichroic mirrors. However, any configuration in which the light beams of three colors are combined is sufficient for the scanning projection apparatus as exemplified by the present embodiment and it may be a configuration of using two dichroic prisms instead of the two dichroic mirrors. Further, the green, red, and blue laser light sources may be arranged differently. Furthermore, a single dichroic cross-prism used generally in a liquid crystal projector or the like may be employed.

Besides, the three collimating lenses 202, 204, and 206 are presumed but it may be configured with a single microlens array.

Moreover, the laser light sources emitting the green, red, and blue light beams are assumed to be packaged separately but they may be housed in the same package.

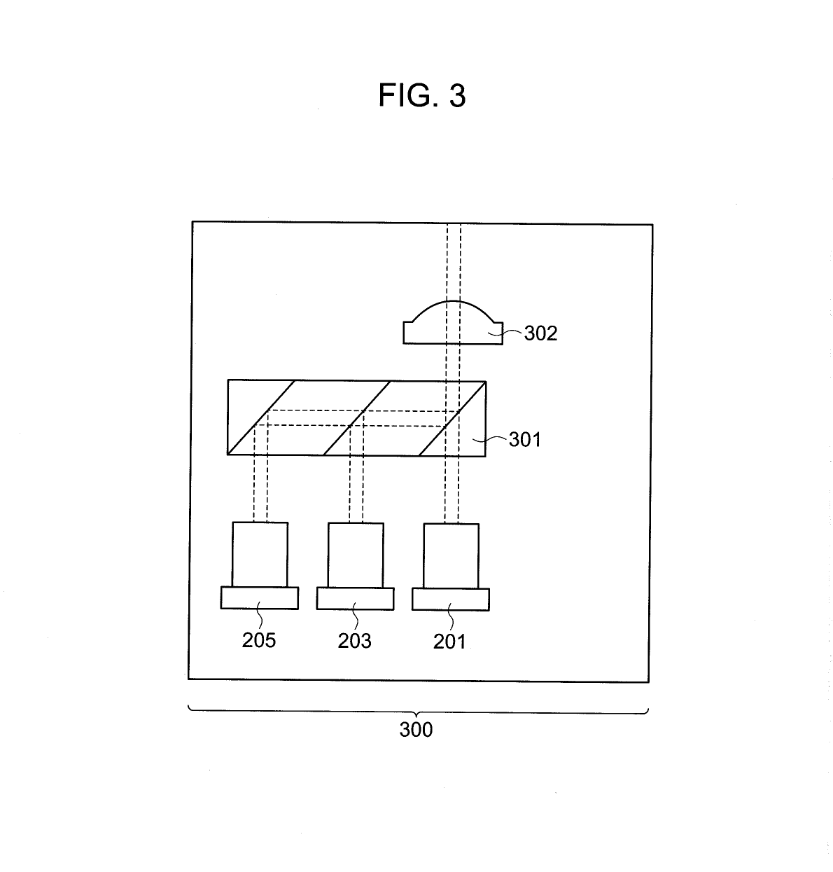

In the present embodiment, it is configured to convert each of the light beams of three individual colors into the collimated beams using each of the three collimating lenses and, thereafter, to combine them into the single light beam of three colors using the two optical beam combiners; like as a scanning projection apparatus 300 shown in FIG. 3, it may be configured so that after a light beam of three colors is formed by an optical beam combiner 301 it is converted into a collimated beam by a single collimating lens 302.

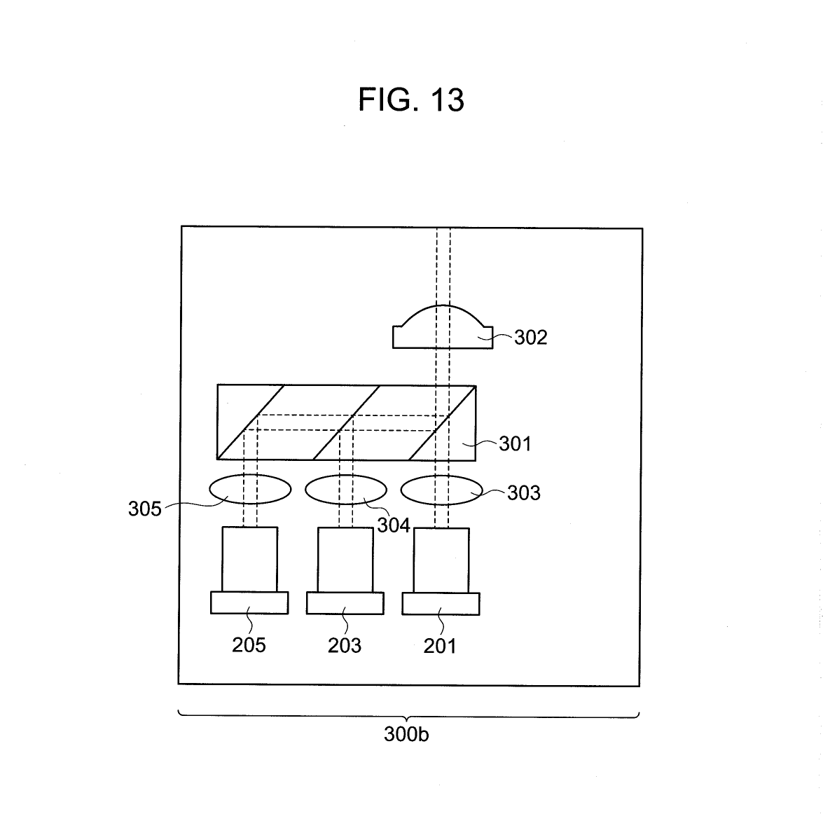

FIG. 13 shows another modification concerning the scanning projection apparatus 300 shown in FIG. 3. A scanning projection apparatus 300b has, in addition to the collimating lens 302, collimating lenses 303, 304, and 305 arranged in association with the laser light sources 201, 203, and 205, respectively. With this construction, while the numerical apertures (NA) from the laser light sources to the collimating lens 302 are kept the same, the distance between each of the laser light sources 201, 203, and 205 and the collimating lens 302 can be extended. As a result, without lowering the utilization of light of a system from each of the laser light sources 201, 203, and 205 to the collimating lens 302, the distance between each of the laser light sources 201, 203, and 205 and the collimating lens 302 can be extended so that there is an advantageous effect of increasing the degree of freedom of the arrangement of an optical beam combiner 301.

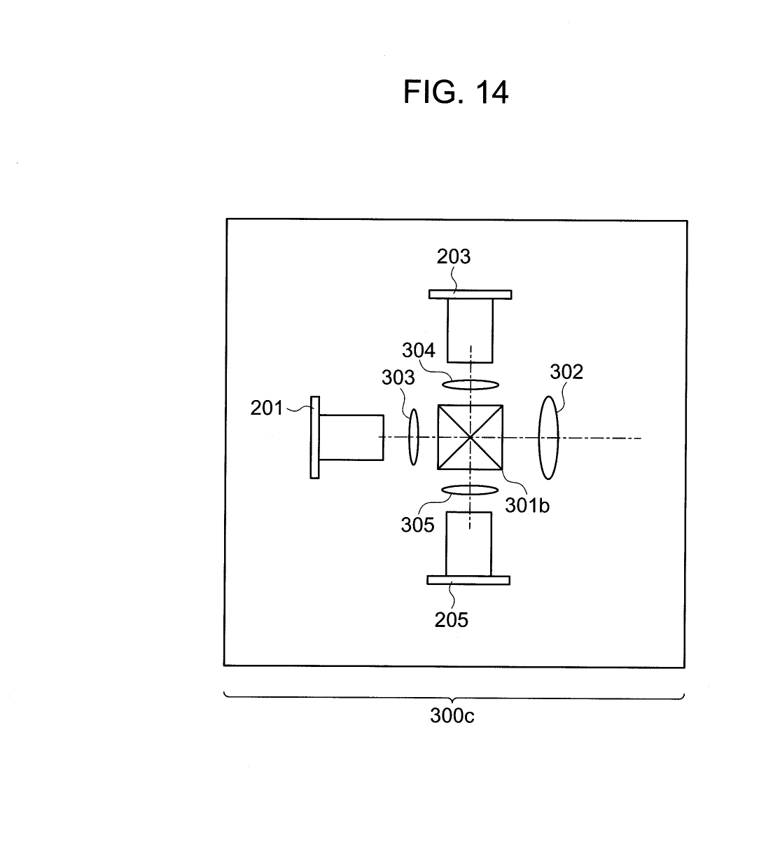

Illustrated in FIG. 14 is still another modification using, as the optical beam combiner, a single dichroic cross-prism 301b, which is used generally in a liquid crystal projector or the like. In this case, too, since substantially collimated beams are obtained with a plurality of collimating lenses, the distance between each of the laser light sources and the collimating lens 302 can be extended so that there is an advantageous effect of enlarging the size or enhancing the degree of freedom of the arrangement of the cross-prism 301b. Incidentally, an example of the positional relationship among the laser light sources 201 (green), 203 (red), and 205 (blue) is illustrated in FIG. 14 and this is not limitative.

As described above, the scanning projection apparatus 100 of the present embodiment can observe the safety standards and implement higher luminance of the image approximately twice as high luminance of the image as that of the convention with a relatively easy construction by forming two images with two light beams of three colors forming a necessarily minimal relative angle therebetween.

### Embodiment 2

Subsequently, Embodiment 2 of the present invention is described with reference to the accompanying drawings.

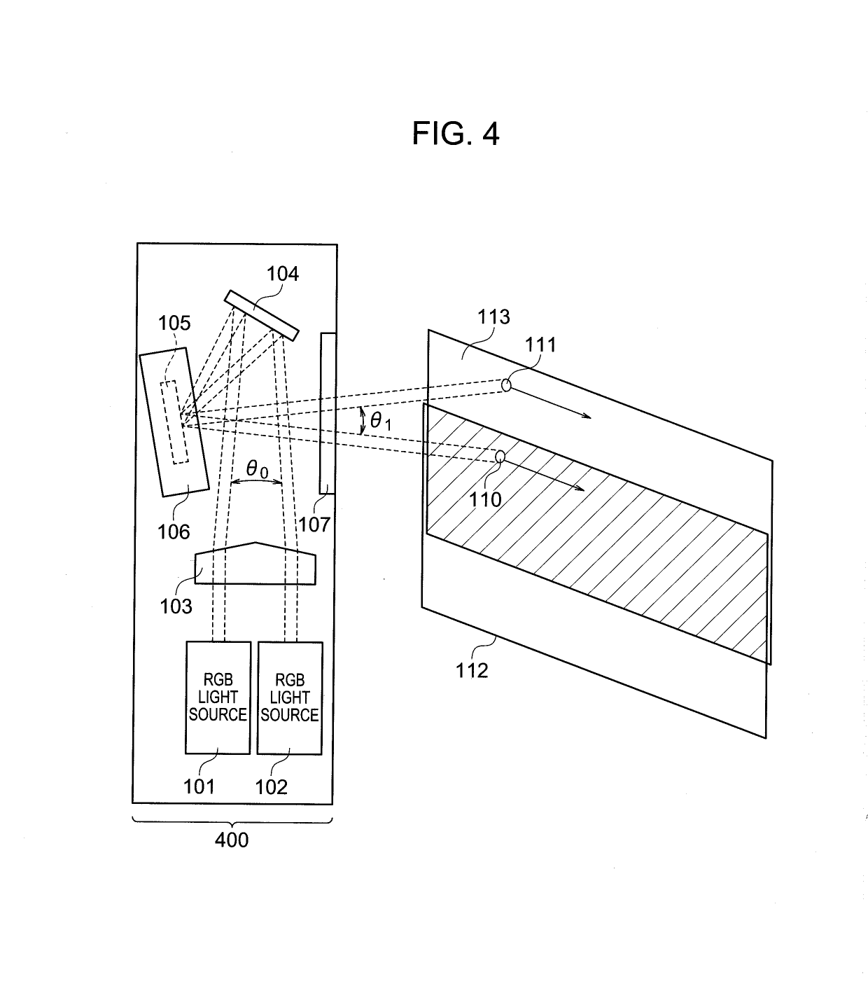

FIG. 4 is a diagram for explaining a scanning projection apparatus 400 in Embodiment 2.

In the scanning projection apparatus 400, an optical refraction element 103 is added to the scanning projection apparatus 100 in Embodiment 1.

The other optical components are the same as those in the scanning projection apparatus 100 and are designated by identical reference numerals. Also, their detailed descriptions are omitted. Two light beams of three colors composed in the RGB light sources 101 and 102, respectively, enter the optical refraction element 103. The optical refraction element 103 is an element which can bend the light beams from the RGB light sources 101 and 102 by arbitrary angles based on the principle of refraction of light. With the optical refraction element 103, the light beams emitted from the RGB light sources 101 and 102 can exit at a relative angle θ₀ therebetween.

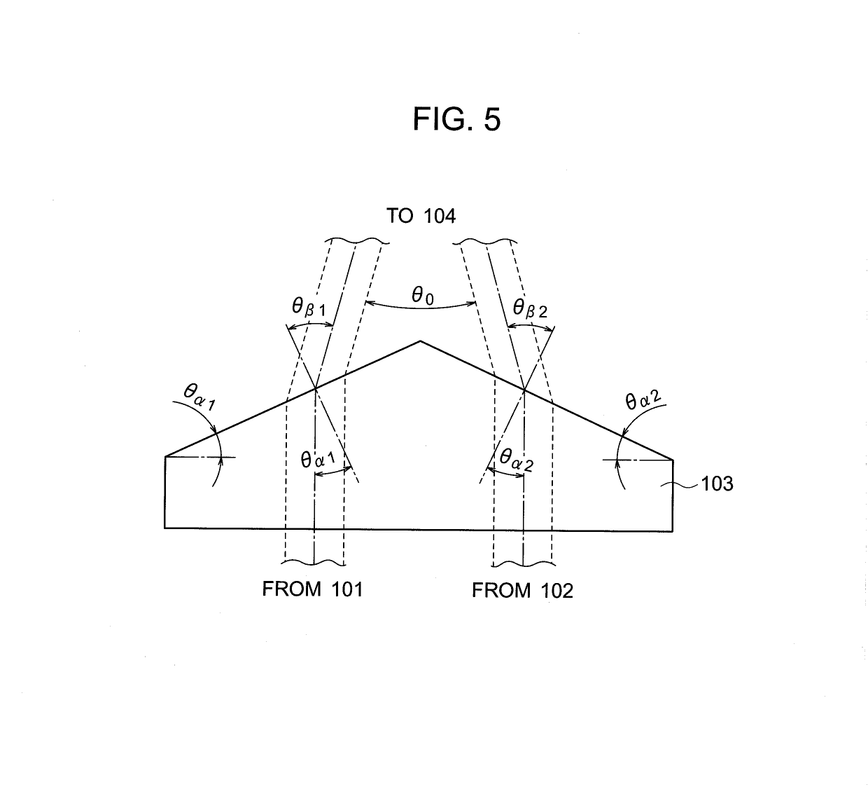

Using FIG. 5, details of the optical refraction element 103 are described. In the figure, alternate long and short dash lines designate optical axes of the light beams and dotted lines designate optical beam diameters. The light beams progress from the bottom to the top in the plane of the drawing. The optical refraction element 103 has an identical shape in an arbitrary cross sectional plane parallel to the plane of the drawing and has, with respect to the propagating direction of the light beam, a perpendicular plane of the incident surface side and a slanted plane of the exit surface side. Since the incident surface side is perpendicular to the light beam, when the light beam enters the optical refraction element 103, it continuously travels straight. When the light beam exits from the optical refraction element 103, however, since the exit surface side is slanted with respect to the light beam, the light beam is refracted. When the two beams are caused to exit from slanted surfaces of different angles, the relative angle between the two beams can be controlled by managing the angles.

A method of calculating a refractive angle θ₀ generated by the optical refraction element 103 in the scanning projection apparatus 400 is explained hereinafter. The refractive index of the optical refraction element 103 is assumed to be n. In the figure, an angle between the normal to the exit surface of the optical refraction element, indicated by an alternate long and short dash line, and the light beam entering the exit surface is assumed to be θ_{α} and an angle between the normal and the light beam exiting from the exit surface is assumed to be θ_{β}.

Then, relations of Equations (1) and (2) are well known according to Snell's law.

n×sin θ_{α1}=sin θ_{β1}. (1)

n×sin θ_{α2}=sin θ_{β2}. (2)

According to Equations (1) and (2), θ_{β1} and θ_{β2} can be calculated by setting θ_{α1} and θ_{α2}. Further, from FIG. 5, the refractive angle θ₀ by the optical refraction element 103 is given by the following equation, Equation (3).

θ₀=(θ_{β1}−θ_{α1})+(θ_{β2}−θ_{α2}) (3)

Incidentally, θ_{α1} and θ_{α2} coincide with the slant angles of the exit surfaces of the optical refraction element 103 in FIG. 5.

From the above, the refractive angle θ₀ can be set arbitrarily by setting the slant angles θ_{α1} and θ_{α2} of the exit surfaces of the optical refraction element 103. By applying the optical refraction element 103, an optics system which has higher accuracy and high reliability against environmental changes can be constructed.

Incidentally, the shape of the optical refraction element 103 is presumed to have the incident surfaces perpendicular to the light beams and the exit surfaces slanted to the light beams but it is not intended to be limited thereto; for example, both the incident and exit surfaces may be slanted to the light beams. Further, since the optical refraction element 103 has different refraction angles for the green, red, and blue light beams, respectively, due to chromatic aberration of a prism, angles of the light beams of three individual colors exiting from the optical refraction element 103 are different from each other. In this case, the angles of the optical beam combiners 207 and 208 or the positions of the respective laser light sources and of the collimating lenses may be adjusted so that the angles of the light beams of three individual colors exiting from the optical refraction element are made coincide with each other.

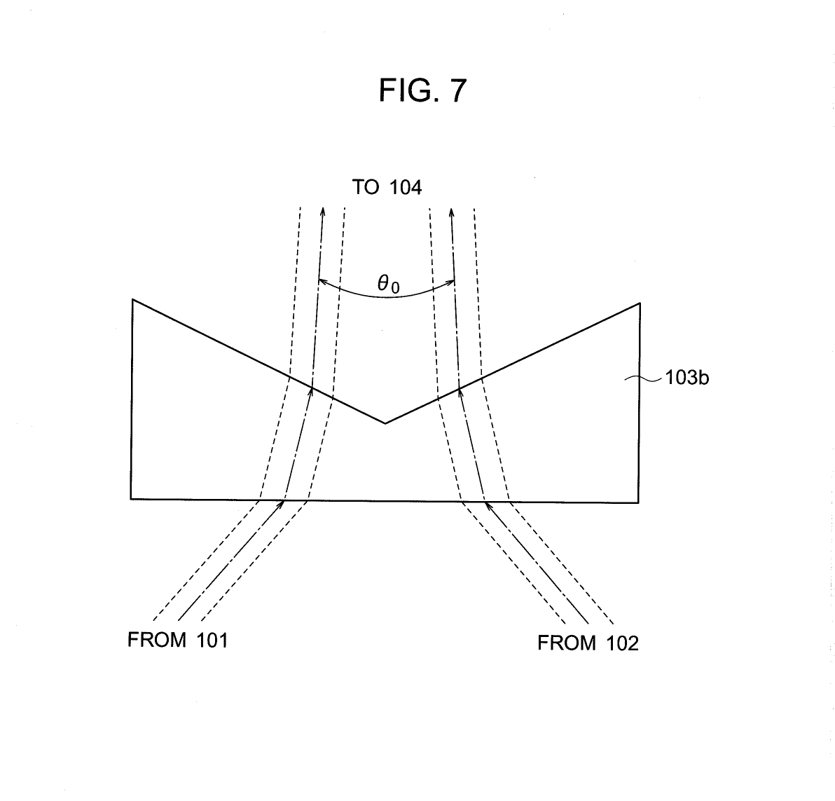

Illustrated in FIG. 7 is another example 103b of the optical refraction element in the scanning projection apparatus 400. In the figure, alternate long and short dash lines indicate optical axes of the light beams and dotted lines indicate optical beam diameters. The light beams progress from the bottom to the top in the plane of the drawing.

The optical refraction element 103b has, with respect to the propagating direction of the light beam, a perpendicular plane of the incident surface side and a slanted plane of the exit surface side; the slanted surfaces have a concave shape in 103b in contrast to the convex shape in 103. With such a structure, the distance between RGB light sources 101 and 102 can be further as seen in the figure. Therefore, the degree of freedom of the arrangement of the RGB light sources 101 and 102 increases.

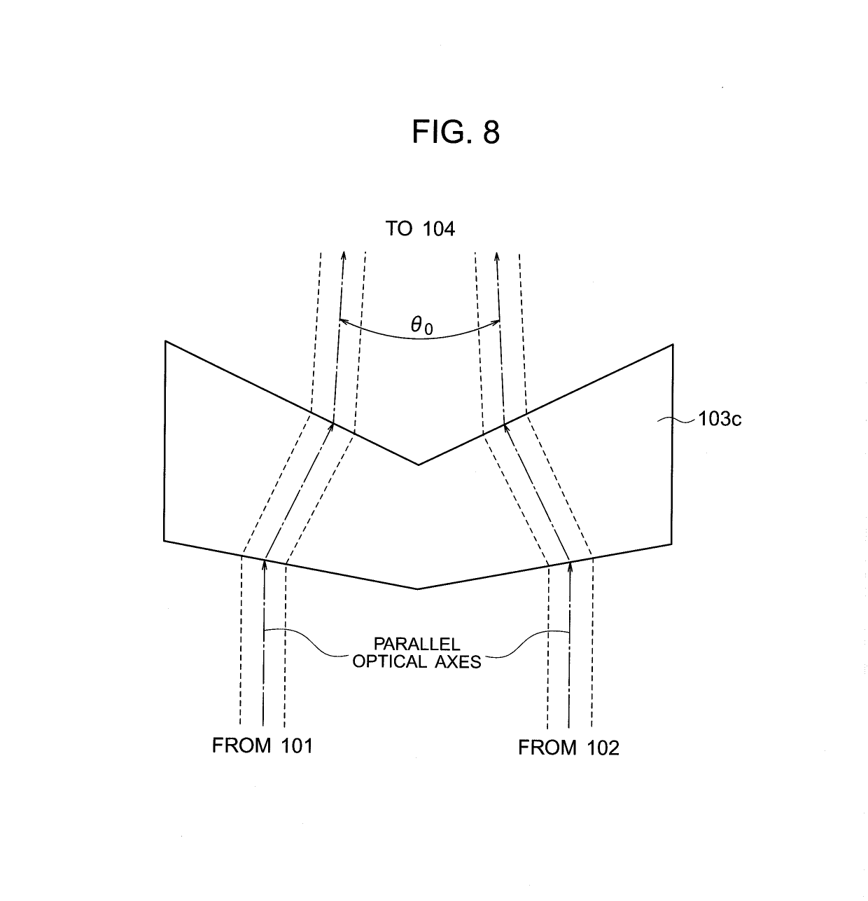

Illustrated in FIG. 8 is another example 103c of the optical refraction element in the scanning projection apparatus 400. In the figure, alternate long and short dash lines indicate optical axes of the light beams and dotted lines indicate optical beam diameters. The light beams progress from the bottom to the top in the plane of the drawing.

In the optical refraction element 103c, with respect to the propagating direction of the light beam, its light beam incident surface side to the element is in a convex shape and its exit surface side is in a concave shape. With such a structure, the light beams from the RGB light sources 101 and 102 can enter the optical refraction element as parallel with each other as shown in the figure. Therefore, the degree of freedom of the arrangement of the RGB light sources 101 and 102 increases and besides, since the light beams emitted from both the RGB light sources can be arranged in parallel, there is an advantageous effect that the overall RGB light sources can be reduced in size.

Incidentally, the above embodiment is described in the case of two light beams to be combined but the number of light beams may be three or four. In that case, each of the optical refraction elements 103, 103b and 103c has the convex shape or the concave shape configured with three or four light beam exit planes.

### Embodiment 3

Next, Embodiment 3 of the present invention is described with reference to the accompanying drawings.

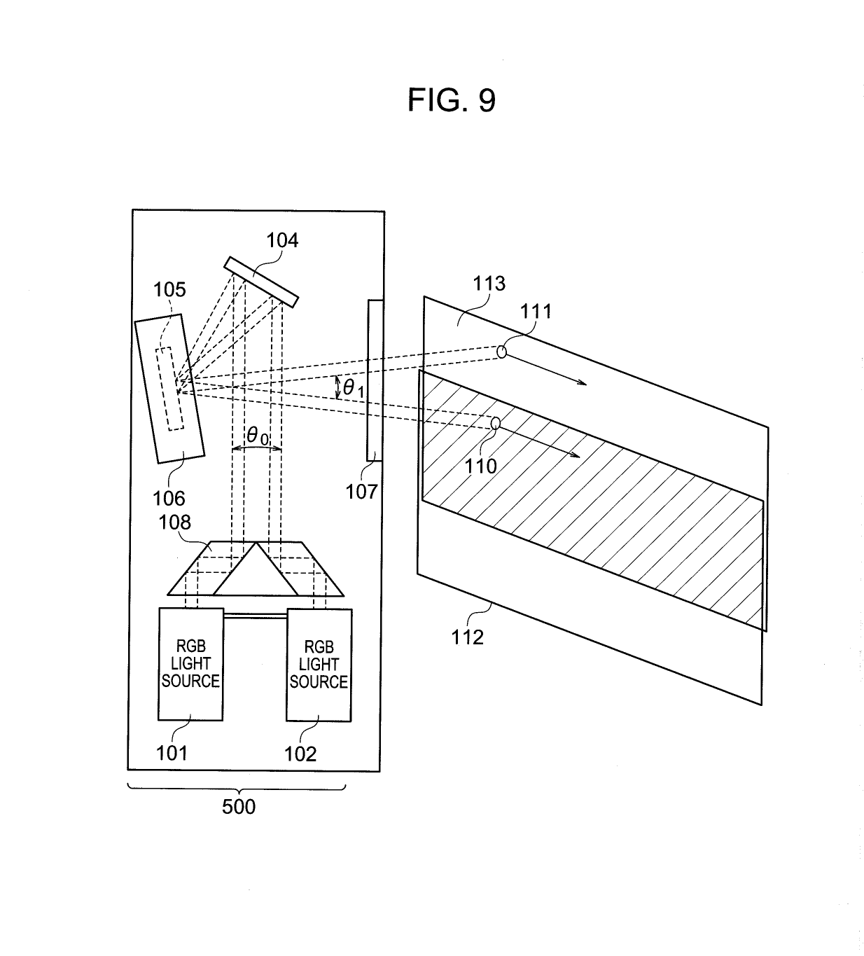

FIG. 9 is a diagram for explaining a scanning projection apparatus 500 according to Embodiment 3.

In the scanning projection apparatus 500, an optical beam combiner 108 is added to the scanning projection apparatus 100 in Embodiment 1.

The other optical components are the same as those in the scanning projection apparatus 100 and are designated by identical reference numerals. Also, their detailed descriptions are omitted. Two light beams of three colors combined in the RGB light sources 101 and 102, respectively, enter the optical beam combiner 108.

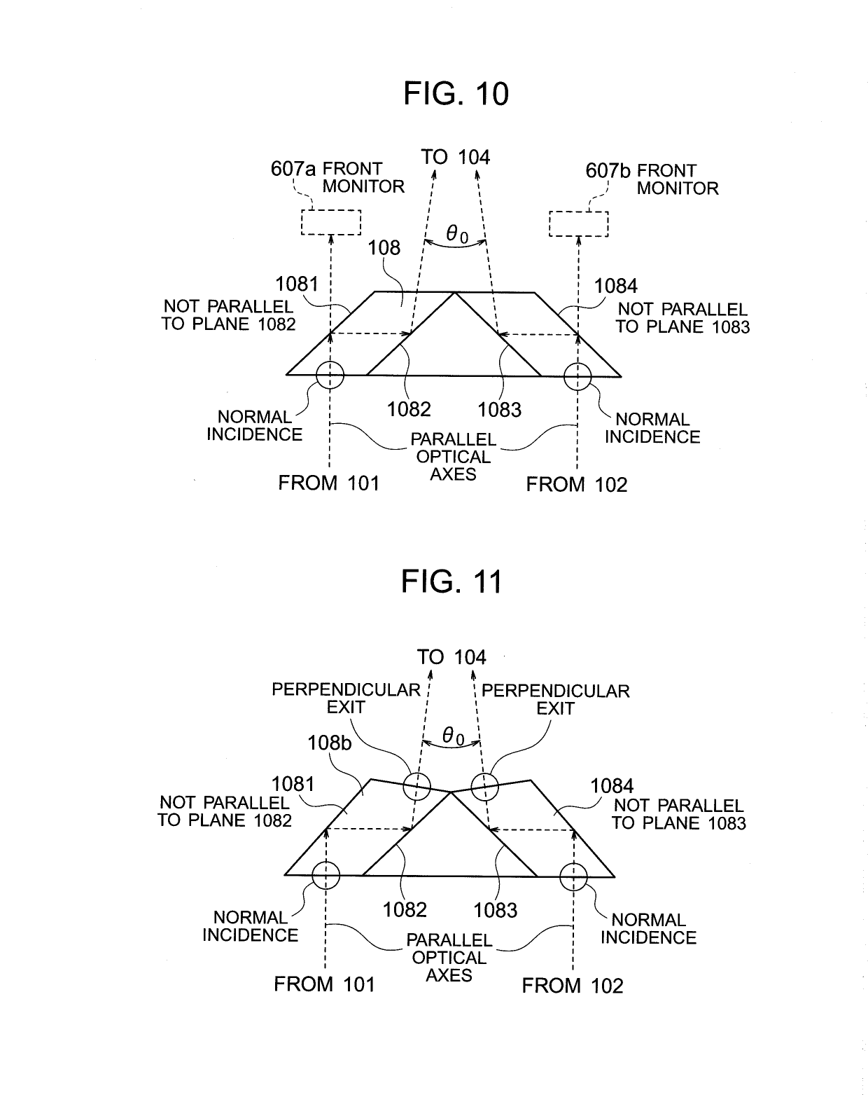

The details of the optical beam combiner 108 is described here with reference to FIG. 10. The optical beam combiner 108 is an optical element of a trapezoidal shape and the light beams from the RGB light sources 101 and 102 enter substantially perpendicularly as shown in the figure. The light beam from the RGB light source 101 is reflected on total reflection planes 1081 and 1802 to exit from the optical beam combiner 108. On the other hand, the light beam from the RGB light source 102 is reflected on total reflection planes 1083 and 1084 and exits from the optical beam combiner 108. By making the planes 1081 and 1082 not parallel with each other and also the planes 1083 and 1084 not parallel with each other, the relative angle between the light beams exiting from the optical beam combiner 108 can be set to a predetermined angle θ₀.

Incidentally, in the embodiment of FIG. 10, optical axes of the light emitted from the laser light sources 101 and 102 are set to be parallel with each other. Also, when the planes 1081 and 1084 are not totally reflective but to transmit part of the light and front monitors 607a and 607b are arranged as indicated by dotted lines in the figure, the intensity of each of the light beams emitted from each of the laser light sources can be detected.

Another example of the optical beam combiner 108 is illustrated in FIG. 11. In an optical beam combiner 108b, the light beams from the laser light sources 101 and 102 enter the optical beam combiner 108b perpendicularly thereto and the angles of respective exit planes are set so that they exit perpendicularly from the end surfaces when they exit from the element. The optical beam combiner 108 is made of an optical material such as, for example, glass; when the light beam exits from the material to the atmosphere, if it exits slanted with respect to the exit end surface, due to the differences in the refractive index of the material depending on wavelengths, the exit angles of individual beams of red, green, and blue slightly deviate from each other. The configuration in which light beams exit perpendicular to the end surfaces has an advantage of mitigating the aforementioned so-called “color divergence”. Of course, even in the structure of FIG. 11, the intensities of the light beams emitted from the individual laser light sources can be detected if the front monitors 607a and 607b as shown in FIG. 10 are arranged.

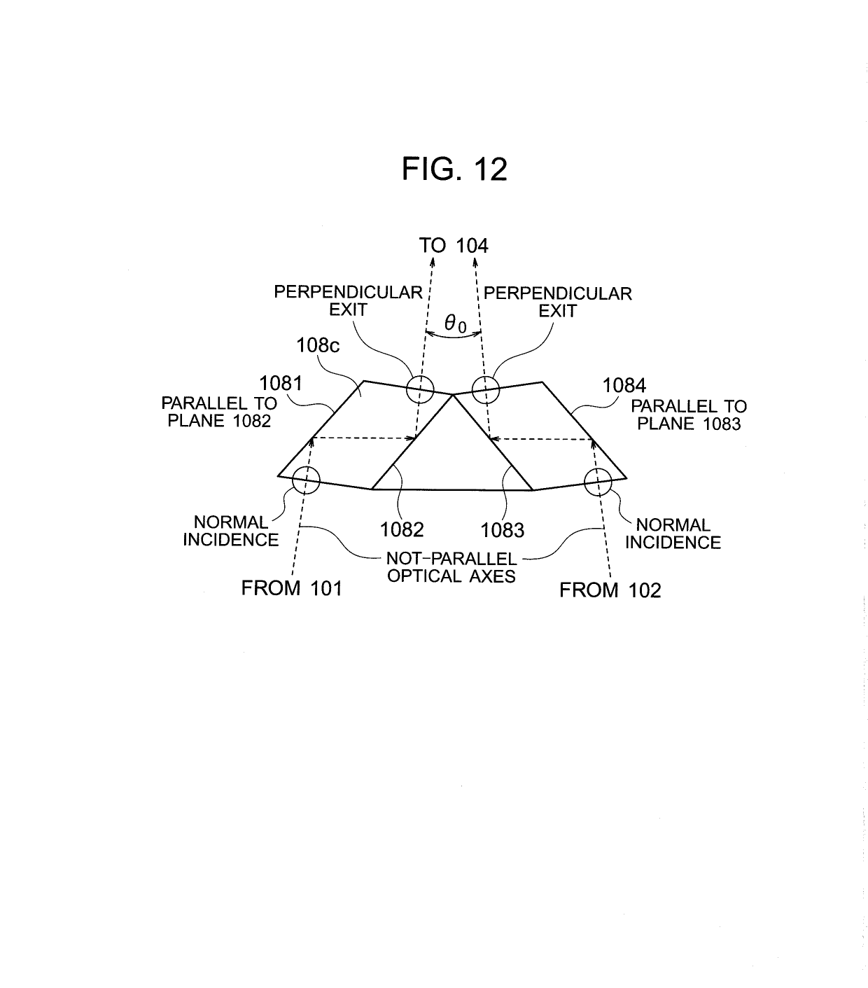

Yet another example of the optical beam combiner 108 is illustrated in FIG. 12. In an optical beam combiner 108c, the light beams from the laser light sources 101 and 102 enter the optical beam combiner 108c perpendicularly thereto but their optical axes are set not parallel to each other. On the other hand, the reflection planes 1081 and 1802 and the reflection planes 1083 and 1084 of the optical beam combiner 108c are set in parallel to each other, respectively. Further, each of the light beams exiting from the optical beam combiner 108c is set to exit perpendicularly from the end surface of the element. In this configuration, in addition to the advantage of mitigating the so-called “color divergence” explained in connection with FIG. 11, there is an advantage of facilitating machining of the element per se since the reflection planes are parallel with each other. Of course, even in the structure of FIG. 12, the intensities of the light beams emitting from the individual laser light sources can be detected if the front monitors 607a and 607b as shown in FIG. 10 are arranged.

### Embodiment 4

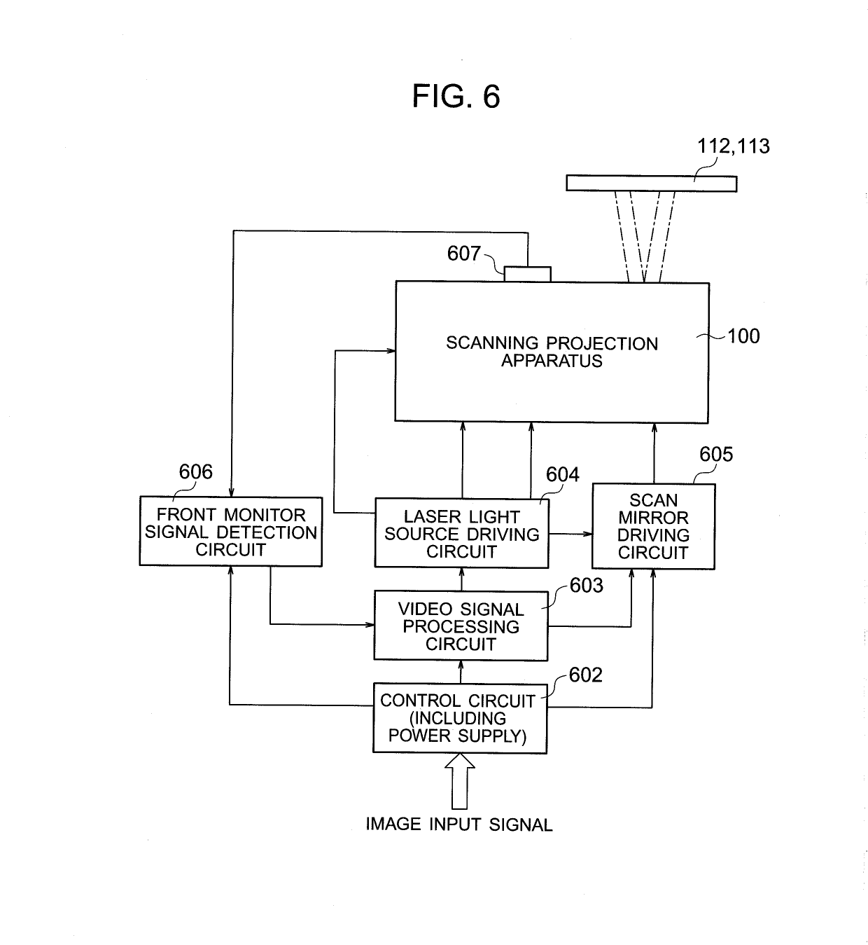

FIG. 6 shows an overall configuration illustrating an embodiment of a scanning image display apparatus according to the present invention.

The scanning projection apparatus 100 includes laser light sources 201, 203, and 205 of three colors of RGB, respectively, an optical combiner part to combine light beams emitted from the individual laser light sources, a projector part to project the combined light beams onto screens 112 and 113, and a scanner part to scan the projected light beams two-dimensionally on the screens 112 and 113.

An image signal to be displayed is inputted to a video signal processing circuit 603 via a control circuit 602 including a power supply and the like. The video signal processing circuit 603 applies various processing to the image signal and divides to three color signals of RGB which in turn are sent to a laser light source driving circuit 604. In accordance with luminance values of individual RGB signals, the laser light source driving circuit 604 supplies operating currents for light emission to the laser light sources 201, 203, and 205 corresponding in the scanning projection apparatus 100. Consequently, the laser light sources 201, 203, and 205 emit light beams having intensities according to luminance values of the RGB signals, respectively, in synchronization with display timing.

The video signal processing circuit 603 also extracts a synchronous signal from the image signal and sends it to a scan mirror driving circuit 605. The scan mirror driving circuit 605 supplies in synchronization with the horizontal/vertical synchronous signals a driving signal to the scan mirror 105 in the scanning projection apparatus 100 to repetitively rotate the mirror surface two-dimensionally. With this, the scan mirror 105 rotates its mirror surface periodically and repetitively by a predetermined angle, thus scanning the light beams on the screens 112 and 113 in the horizontal and vertical directions to display an image.

By receiving an input signal from a front monitor 607 in the scanning projection apparatus 100, a front monitor signal detection circuit 606 detects output levels of respective RGB emitted from the laser light sources 201, 203, and 205. The detected output levels are inputted to the video signal processing circuit 603 so that the outputs of the laser light sources 201, 203, and 205 are controlled to have predetermined outputs.

### Embodiment 5

In Embodiment 5, six modified examples of the two-beam combining method in the former Embodiment 1 are described.

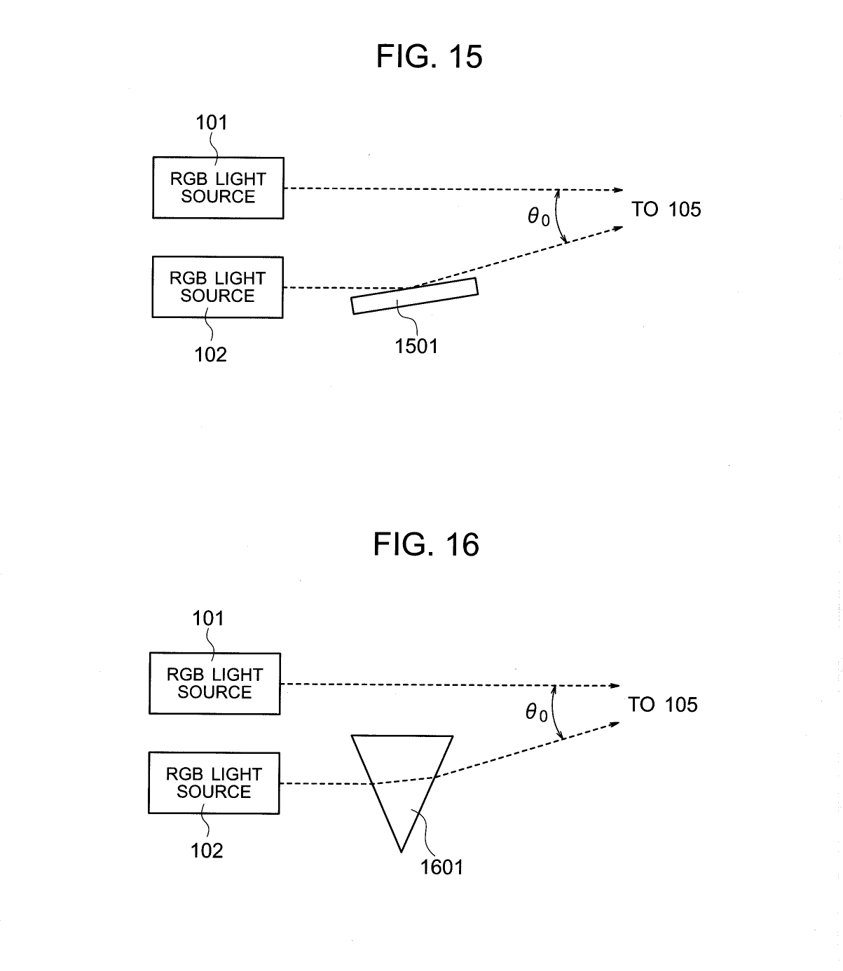

FIG. 15 shows a first modification of the two-beam combining method in Embodiment 1.

Light beams emitted from the RGB light sources 101 and 102 are substantially parallel to each other. An optical path of the light beam emitted from the RGB light source 102 is bent by a mirror 1501 so that it becomes a light beam with a predetermined relative angle θₒ with the light beam emitted from the RGB light source 101 and enters the scan mirror 105. Since the light beams emitted from the RGB light sources 101 and 102 are substantially parallel to each other, there is an advantage that assembly and adjustment of both the light sources are facilitated.

FIG. 16 shows a second modification of the two-beam combining method in Embodiment 1.

Light beams emitted from the RGB light sources 101 and 102 are substantially parallel to each other. An optical path of the light beam emitted from the RGB light source 102 is bent by a prism 1601 so that it becomes a light beam with a predetermined relative angle θ₀ with the light beam emitted from the RGB light source 101 and enters the scan mirror 105. Also in this configuration, since the light beams emitted from the RGB light sources 101 and 102 are substantially parallel to each other, there is an advantage that assembly and adjustment of both the light sources are facilitated.

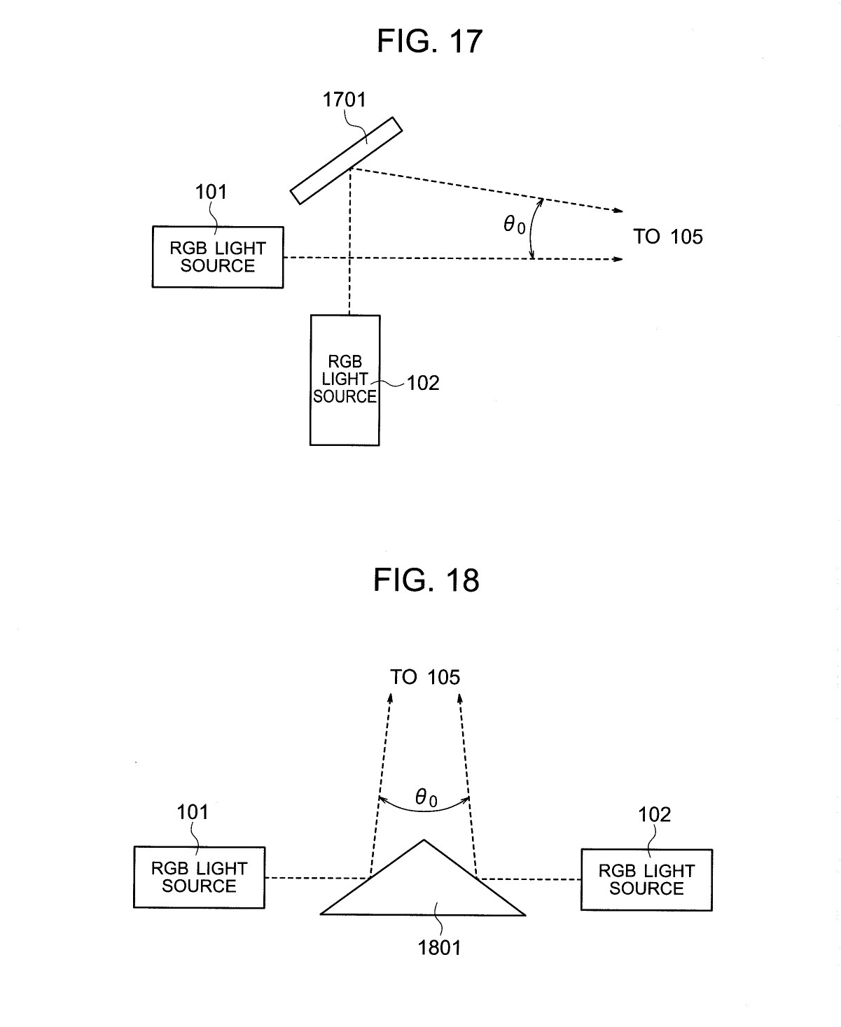

Illustrated in FIG. 17 is a third modification of the two-beam combining method in Embodiment 1.

Light beams emitted from the RGB light sources 101 and 102 intersect with each other substantially perpendicularly. Further, an optical path of the light beam emitted from the RGB light source 102 is bent by a mirror 1701 so that it becomes a light beam with a predetermined relative angle θ₀ with the light beam emitted from the RGB light source 101 and enters the scan mirror 105. In this configuration, the size of the overall shape can be reduced. In addition, since the positions of the RGB light sources 101 and 102 can be separated away with each other, there is an advantage that the degree of freedom in a construction and an arrangement of assembling facilities is increased.

Illustrated in FIG. 18 is a fourth modification of the two-beam combining method in Embodiment 1.

The RGB light sources 101 and 102 are arranged to oppose to each other and the light beams emitted from both the light sources are reflected by a triangular mirror 1801 to become light beams having a predetermined relative angle θ₀ therebetween and enter the scan mirror 105. In this configuration, the size of the overall shape can be reduced. In addition, since the positions of the RGB light sources 101 and 102 can be separated away with each other, there is an advantage that the degree of freedom in a construction and an arrangement of assembling facilities is increased.

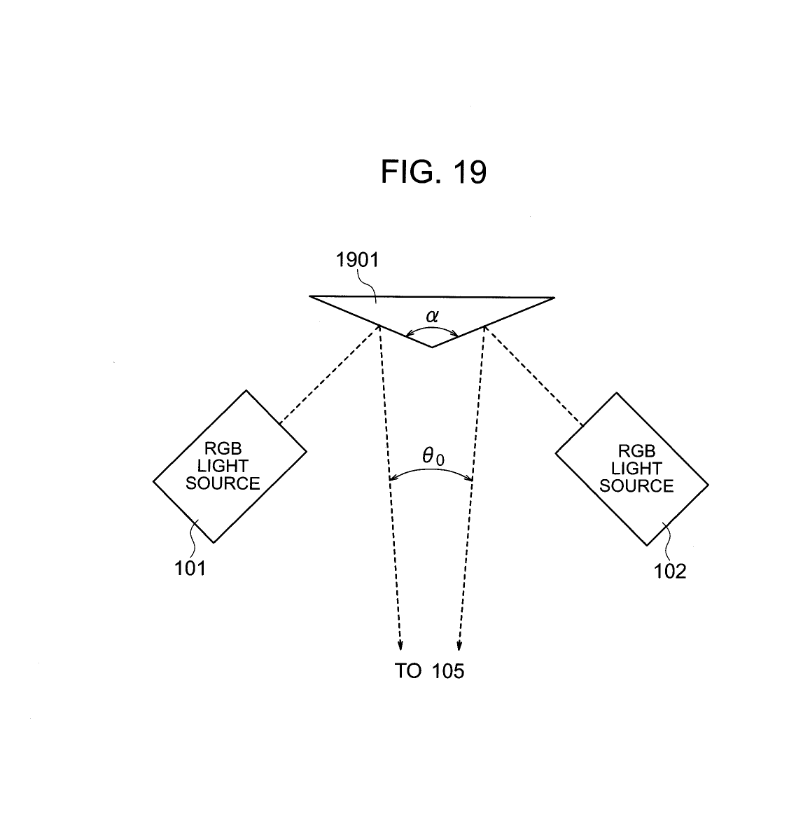

Illustrated in FIG. 19 is a fifth modification of the two-beam combining method in Embodiment 1.

Light beams emitted from the RGB light sources 101 and 102 are reflected by a triangular mirror 1901 toward the RGB light sources so that they become light beams having a predetermined relative angle θ₀ therebetween and enter the scan mirror 105. By changing a vertical angle α of the triangular mirror 1901, arrangement positions of the RGB light sources 101 and 102 can be changed. Therefore, in this configuration, the size of the overall shape can be reduced and, besides, there is an advantage that the degree of freedom in a construction and an arrangement of assembling facilities is increased.

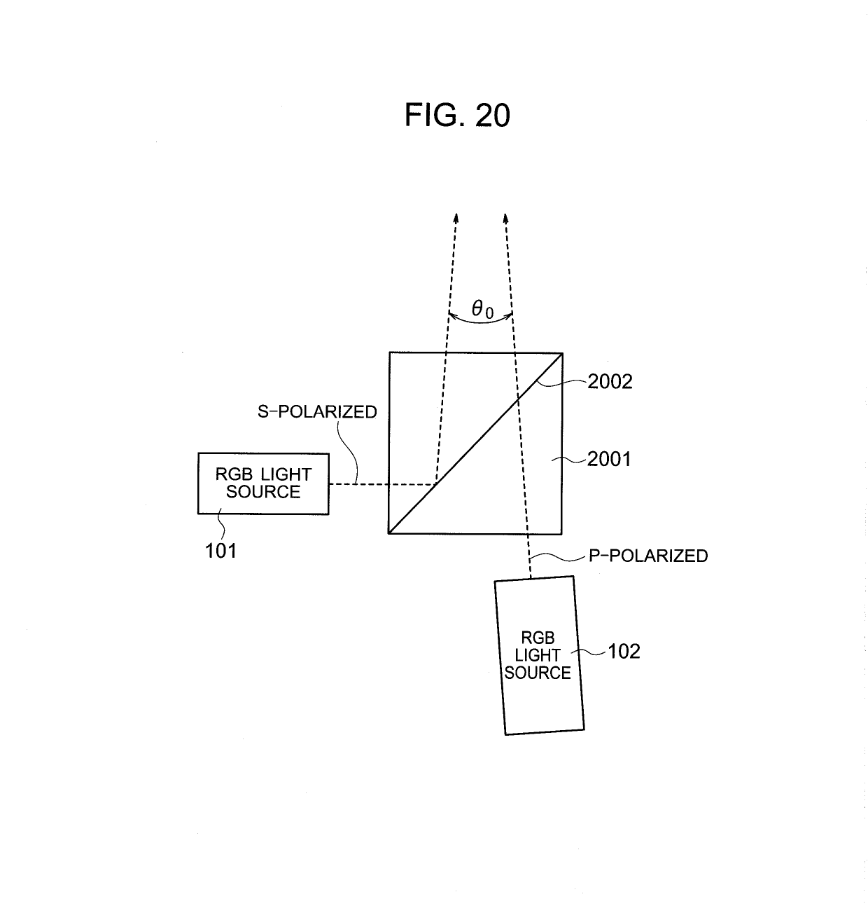

FIG. 20 shows a sixth modification of the two-beam combining method in Embodiment 1.

With respect to a reflection plane 2002 of a polarizing beam splitter 2001, exit light of the RGB light source 101 and the exit light of the RGB light source 102 are set to be S-polarized and P-polarized, respectively. Making the light beams emitted from the RGB light sources 101 and 102 have a predetermined relative angle θ₀ can be accomplished by setting incident angles of the light beams entering the polarizing beam splitter 2001 or relative angles between the reflection plane 2002 and incident beams to desired values. In this configuration, there is an advantage that the size of the overall shape can be reduced.

### Embodiment 6

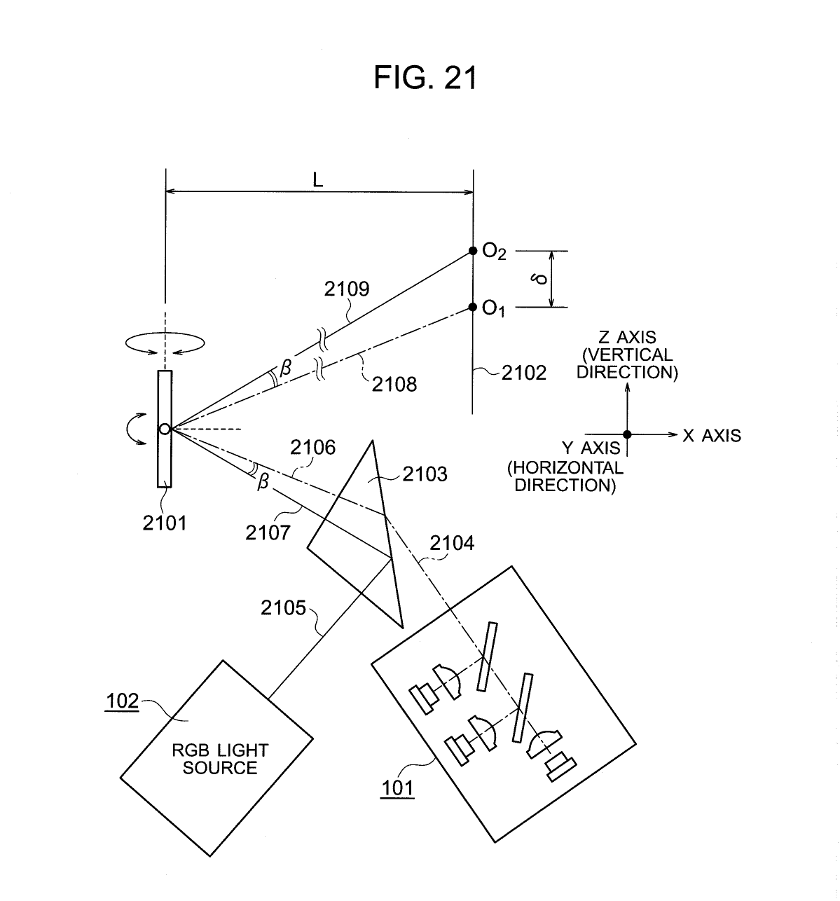

FIG. 21 is a schematic side view showing an embodiment associated with a scanning projection apparatus and a scanning image display according to the present invention. Like Embodiments 1 to 3, the scanning projection apparatus according to the present embodiment includes light source units 101 and 102 which generate and emit light beams for image display independent of each other, a scan mirror device 2101 which deflects and scans the light beams two-dimensionally, and an optical beam combiner 2103 having a function to combine the light beams for image display 2104 and 2105 which are emitted from the light source units 101 and 102, respectively, and to cause them to enter a reflection mirror in the scan mirror device 2101 together, as principal optical components. Incidentally, the light source units 101 and 102, which are RGB light sources can be identical to the light source units shown prior in connection with FIG. 2 and, to avoid complication, reference numerals of their constituent elements are omitted in FIG. 21.

First, the schematic configuration of the interiors of the light source units 101 and 102 are explained. In the light source unit 101, three laser light sources 201, 203, and 205 are arranged having wavelengths which are different from each other. The laser light source 201 is a laser diode light source which emits a green laser light of, for example, a wavelength of 520 nm band. The green light beam emitted from the laser diode light source 201 is converted to a substantially collimated light beam by a collimating lens 202 and then enters a flat mirror 207. The laser light source 203 is a laser diode light source which emits a red laser light of, for example, a wavelength of 640 nm band. The red light beam emitted from the laser diode light source 203 is also converted to a substantially collimated light beam by a collimating lens 204, like the green light beam emitted from the above-mentioned laser diode light source 201, and then enters the flat mirror 207, which is an optical beam combiner.

The flat mirror 207 is a first dichroic mirror having a function of transmitting the green light beam emitted from the above laser diode light source 201 at a predetermined transmittance and of reflecting the red light beam emitted from the above laser diode light source 203 at a predetermined reflectance; the respective light beams transmitting through or reflected at the flat mirror 207 progress the substantially identical optical paths so as to enter a flat mirror 208, which is an optical beam combiner. On the other hand, the light source 205 is a laser diode light source which emits a blue laser light of, for example, a wavelength of 440 nm band. The blue light beam emitted from the laser diode light source 205 is converted to a substantially collimated light beam by a collimating lens 206 and then enters the flat mirror 208.

The flat mirror 208 is a second dichroic mirror having a function of transmitting the above green and red light beams at predetermined transmittances and of reflecting the above blue light beam at a predetermined reflectance.

Then, the respective green, red, and blue light beams transmitting through or reflected at the second dichroic mirror 208 exit from the light source unit 101 in such a condition that inclinations and positions of their respective optical axes are adjusted stringently for the respective cross-sections of luminous fluxes to be overlapped with each other and to form a substantially single light beam and progress in a form of a light beam for image display 2104.

In the present embodiment, an light source unit 102 is also in the identical component configuration as the above light source unit 101 and functions to emit a light beam for image display 2105 which is identical to the light beam for image display 2104 emitted from the above light source unit 101. Therefore, in FIG. 21, the configuration diagram of the internal components in the light source unit 102 is omitted.

However, regarding the light source units 101 and 102, they are not limited to the above configuration naturally and, for example, may of course be light source units using other types of light sources such as LED light sources other than the laser diode light sources as respective green, red, and blue light sources.

Besides, it may have any configuration as far as it is a light source unit having the function of emitting a light beam for displaying by projection an image by deflection scanning. Furthermore, the internal component configurations of the light source units 101 and 102 may differ from each other.

Subsequently, the light beams 2104 and 2105 for image display emitted from the above light source units 101 and 102, respectively, reach an optical beam combiner 2103 from different directions as shown in FIG. 21.

First, the light beam for image display 2104 emitted from the light source unit 101 is incident on a predetermined smooth surface of the optical beam combiner 2103 as shown in the figure and transmits through the surface to progress the inside of the optical beam combiner 2103.

On the other hand, the light beam for image display 2105 emitted from the light source unit 102 enters similarly the optical beam combiner 2103 from a direction different from that of the light beam 2104, progresses inside the element 2103, and is incident on the identical surface to the smooth surface on which the light beam 2104 is incident in the direction of from the inside to the outside of the element 2103 opposing to the light beam 2104.

Then, by being reflected on the smooth surface it is deflected to an optical path direction substantially the same as the optical path direction of the above light beam 2104; they become light beams 2106 and 2107, respectively, and exit from the optical beam combiner 2103 together.

Incidentally, the structure, function, and the like of the optical beam combiner 2103 are described later in detail.

Subsequently, the light beams 2106 and 2107 exiting from the optical beam combiner 2103 enter the scan mirror device 2101 for light beam scan together. Here, the light beams 2106 and 2107 are so set as to be incident on a reflection mirror surface in the scan mirror device 2101 with a predetermined slight relative angle (aperture angle) β in the vertical direction (the direction of the z axis in the figure), namely in the direction of the up and down in the plane of paper.

Incidentally, the scan mirror device 2101 for scanning the above light beams is a device referred to as a so-called biaxial mono-surface scan mirror; while the light beams 2106 and 2107 entering a predetermined reflection mirror arranged in the apparatus are reflected to project reflected light beams 2108 and 2109 onto a projection screen 2102 away from the scan mirror device 2101 by a predetermined distance, the reflection mirror surface per se has a function of performing periodical repetitive deflection drive by predetermined angles at high speeds about a rotating axis substantially perpendicular to the plane of the paper, namely a rotating axis substantially parallel to the Y axis in the figure, and about a rotating axis substantially parallel to the plane of the paper and substantially parallel to the Z axis in the figure, respectively.

By the high-speed repetitive deflection drive of the reflection mirror, the reflected light beams 2108 and 2109 projected on the projection screen 2102 are scanned two-dimensionally repetitively at high speeds in the horizontal direction (the Y axis direction in the figure) and in the vertical direction (the Z axis direction in the figure) on the surface of the projection screen 2102.

At this moment, by modulating respectively independently optical outputs of the light sources 201, 203, and 205 inside each of the light source units 101 and 102 in synchronization with individual instantaneous irradiation positions of the reflected light beams 2108 and 2109 undergoing repetitive scans on the projection screen 2102, a two-dimensional color image can be displayed on the projection screen 2102 using the afterimage phenomenon of human eyes.

Incidentally, in conventional scanning projection apparatuses or scanning image displays, usually only one light beam for image display is projected onto the projection screen. The configuration in which two or more light beams for image display are projected on the projection screen as in the present embodiment is one of the major features of the present invention.

Further, as examples of the structure of the mirror driving part in the scan mirror device 2101 for light beam scanning as described above, there are, for example, a Micro Electro Mechanical Systems (abbreviated as MEMS), electromagnetically driven galvano-mirrors, or the like; the present invention is, however, not limited thereto and, since specific configurations of these scan mirror device driving part has no direct relation to the present invention, their detailed description is omitted.

Also understandably, the scan mirror device for light beam scanning used in the present application is not limited to the aforementioned biaxial mono-surface scan mirror device; provided that the device has the function to scan the light beams two-dimensionally at high speed, any device can be used such as, for example, a device of two mono-axial mono-surface scan mirrors which has scan mirrors for two independent faces substantially perpendicular with each other and driven to undergo high-speed repetitive scan about a single axis so that incident light beams may be sequentially reflected by the scan mirror with two faces.

Incidentally, as described above, the light beams for image display 2106 and 2107 are incident to the reflection mirror in the scan mirror device 2101 with a relative slant angle (aperture angle) β. Therefore, when no special optical component or element is disposed particularly on an optical path between the scan mirror device 2101 and the projection screen 2102 as in the embodiment of FIG. 21, the light beams 2108 and 2109 reflected on the above reflection mirror and subject to high-speed repetitive scan in two-dimensional directions conduct high-speed repetitive scan on the projection screen 2102 while always maintaining the relative slant angle (aperture angle) of the angle β.

Consequently, as shown in FIG. 21, for example, at an instant that the reflected light beam 2108 of the light beam 2106 passes on an arbitrary point O₁ on the projection screen 2102, the reflected light beam 2109 of the light beam 2107 passes on a point O₂ also on the projection screen 2102 and located away by a distance δ in the vertical direction, namely in the Z axis direction in the figure. The separation amount δ can be expressed by the following equation (4) when a distance L between the scan mirror device 2101 and the projection screen 2102 is sufficiently larger than a size of an image displayed by projection on the projection screen 2102.

δ≈L×tan [β] (4)

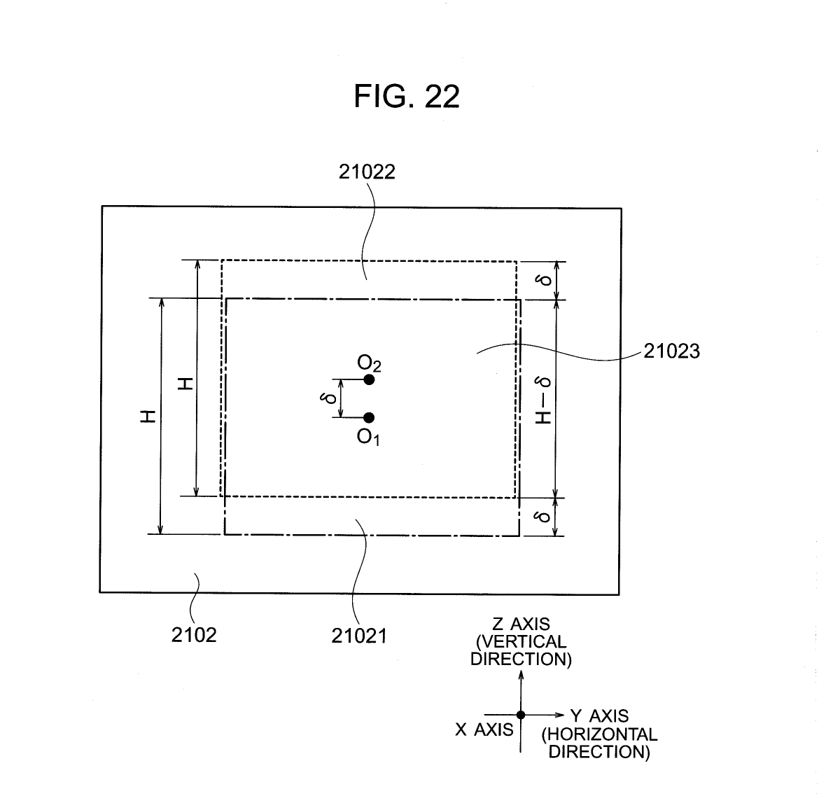

FIG. 22 is a schematic front view showing sizes and positional relations of images displayed by projection on the projection screen 2102 by the scanning image display using the scanning projection apparatus as shown in FIG. 21.

Here, it is provided that a substantially rectangular image display area 21021 displayed by high-speed repetitive scanning of the light beam for image display 2108 shown in FIG. 21 on the projection screen 2102 is indicated in alternate long and short dash lines in FIG. 22 and that also a substantially rectangular image display area 21022 displayed by high-speed repetitive scanning of the light beam for image display 2109 on the projection screen 2102 is indicated in dotted lines in FIG. 22.

At that time, the image display areas 21021 and 21022 are displayed at positions separated from each other by the separation amount δ expressed by the above Equation (4) in the vertical direction, namely the Z axis direction in the figure.

While designating image heights in the vertical direction (the Z axis direction) of both the image display areas 21021 and 21022 with H as shown in the figure, when a separation amount δ is a small quantity compared with H, a two-image overlapping area 21023, where the image display areas 21021 and 21022 overlap, corresponding to a image height of H−δ is created at an intermediate position of the display areas 21021 and 21022.

In the two-image overlapping area 21023, the image displayed by the light beam 2108 and the image displayed by the light beam 2109 are overlapped with each other. Thus, when the two images to be overlapped are displayed with exactly the same image and the luminance, the luminance of the displayed image is doubled in the two-image overlapping area 21023.

However, as described above, since the image display areas 21021 and 21022 are separated from each other by the separation amount δ in the vertical direction, namely the Z axis direction, and, not surprisingly, the images displayed in the respective image display areas are displayed as separated relatively by δ.

Accordingly, in order that doubling the luminance by overlapping the respective images with a perfect match in the two-image overlapping area 21023, the two overlapping images must be displayed by shifting them relatively by −δ in the vertical direction, namely the Z axis direction in the figure.

Incidentally, the size of the two-image overlapping area 21023, namely its image height is indicated by H−δ as described above. Accordingly, the smaller the separation amount δ, the larger the two-image overlapping area 21023 can be secured, which is advantageous. Additionally, if δ=0, a two-image overlapping area 21023 having perfectly the same image height H as that of each of the original image display areas 21021 and 21022 can be secured.

Making the separation amount δ infinitely small, however, runs the risk of creating a serious problem in safety of the optical apparatus.

For example, in case a person accidentally peeks into the light beams for image display 2108 and 2109 undergoing high-speed repetitive scan during image display from a side of the projection screen 2102, when the separation amount δ of the two beams is smaller than a predetermined value, there is a possibility that the two beams simultaneously enter the eyeball of the person so as to be incident on the retina.

If such an accident occurs, energy (intensity) of the light beam irradiated on the retina naturally doubles the energy of each of the light beams. Consequently, even when the optical energy (intensity) of each light beam is equal to or below the value pursuant to the safety standards of the laser safety, the doubled optical energy (intensity) may exceed the value of the safety standards to raise danger leading to a serious accident such as damaging the retina or loss of eyesight at the worst.

Therefore, it is indispensable at least to prevent two or more light beams from rushing into an eyeball simultaneously even when a person may accidentally peek into the light beams.

Now, supposedly an instance is presumed in which a person accidentally peeks into the light beams for image display 2108 and 2109 from a position 10 cm (=100 mm) away from the scan mirror device 2101. For example, when the relative slant angle β between the light beams 2108 and 2109 is set to 4°, the separation amount Se between both the beams on the eyeball is determined as about 7 mm through calculation with substituting L=100 mm and β=4° to the Equation (4). When the relative slant angle β is set to 5°, the light beam separation amount δe on the eyeball amounts to about 8.8 mm.

The size of a human eyeball is said to have a diameter of approximately 7 mm or less though there are individual differences. Accordingly, by setting the relative slant angle β between the light beams 2108 and 2109 to at least 4° or more, preferably 5° or more, the two or more light beams can be prevented from rushing into an eyeball simultaneously even when a person accidentally peeks into the light beams for image display from the position 10 cm away from the scan mirror device 2101.

Incidentally, when the relative slant angle β between the light beams 2108 and 2109 is presumably set to 5°, the separation amount δ is about 88 mm on the projection screen 2102 which is away by, for example, L=1 m (1000 mm).

Now assuming that each of the image display areas 21021 and 21022 is a general image display area having an aspect ratio of 4:3 and that the size of the displayed image at this position is approximately 20 inches, the image height H in its vertical direction is about 300 mm. Therefore, the image height of the above two-image overlapping area H−δ is 212 mm eventually, indicating that about 70% in terms of the image height of the original image display areas 21021 and 21022 can be the two-image overlapping area. And in this two-image overlapping area, using the aforementioned image overlapping method the luminance of the displayed image can be doubled without increasing the intensity of each of the light beams for image display.

The contents of the aforementioned description, incidentally, gives an explanation of the most fundamental embodiment of the present invention in which the two displayed images displayed on the projection screen 2102 by the two independent light beams for image display are overlapped with each other with the predetermined separation amount δ in the vertical direction as shown in FIGS. 21 and 22; the present invention is by no means limited thereto. The number of images to be overlapped may be three or more images, and the separation direction of the plurality of images is not limited to the vertical direction; it may be the horizontal direction or may be an arbitrary direction, which is neither of them.

Next, regarding an example structure and its function of the optical beam combiner 2103 exemplified in connection with the embodiment of FIG. 21 is now described in detail.

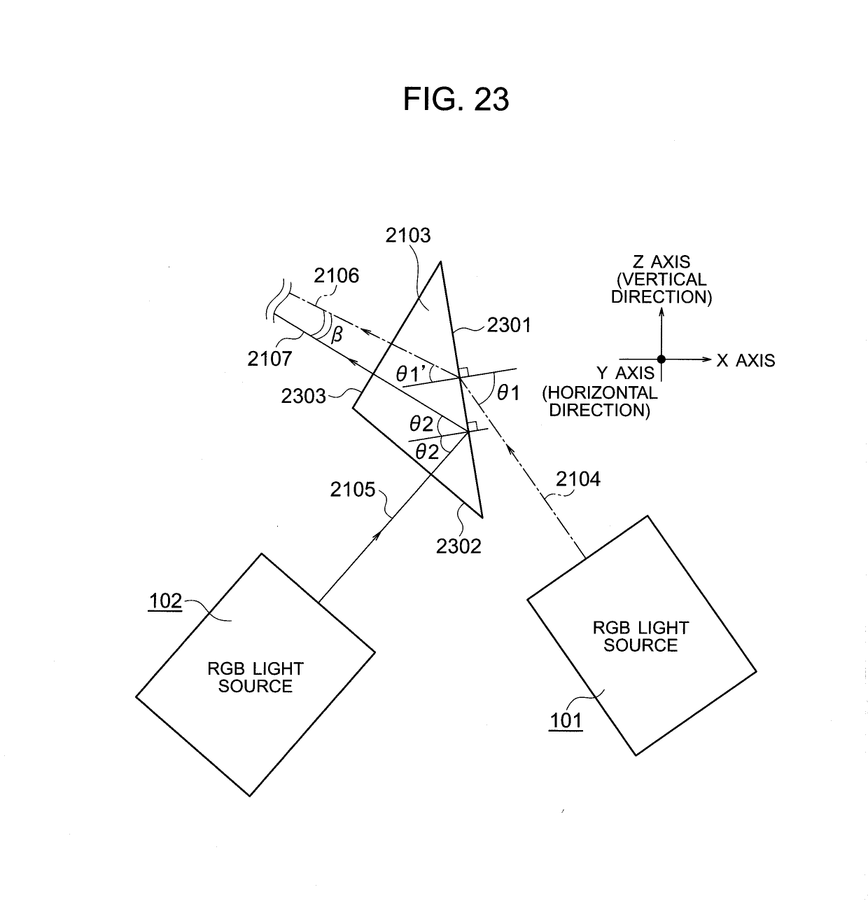

FIG. 23 is a schematic side view showing only the principal portion centered at the optical beam combiner 2103 in the scanning projection apparatus shown in FIG. 21.

Here, the optical beam combiner 2103 takes an optical prism structure of a triangle pole shape having three transparent smooth surfaces 2301, 2302, and 2303 as shown in the figure, for example.

A light beam for image display 2104 exiting from the light source unit 101 is incident on the smooth surface 2301 of the optical beam combiner 2103 as shown in the figure.

Here, representing the incident angle of the light beam 2104 onto the smooth surface 2301 with θ1 and the refraction angle of the light beam which transmits through the smooth surface 2301 and is refracted to propagate in the optical beam combiner 2103 with θ1′, when this light beam 2104 is a light beam being linearly polarized in a polarization direction parallel to the plane of the paper (hereinafter, such polarized light is referred to as P-polarized light), the following relational equation generally called Fresnel formulae holds among the incident angle θ1, the refraction angle θ1′ and an intensity reflectivity R1 of the light beam 2104 on the smooth surface 2301.

R1={tan [θ1−θ1′]/tan [θ1+θ1]}². (5)

Further, between the incident angle θ1 and the refraction angle θ1′, the following relational equation holds from the basic law of refraction (Snell's law), where n represents a refractive index of the optical beam combiner 2103 and a refractive index of the outside (the atmosphere) is 1:

sin [θ1′]=sin [θ1]/n. (6)

By using these Equations (5) and (6), the intensity reflectivity R1 of the light beam 2104 incident on the smooth surface 2301 can be determined using the incident angle θ1 and the refractive index n of the optical beam combiner 2103.

On the other hand, the light beam for image display 2105 emitted from the light source unit 102 enters the optical beam combiner 2103 once through the smooth surface 2302, progresses in the combiner 2103, and reaches the smooth surface 2301 as shown in the figure. Then, it is incident on the smooth surface 2301 inversely to the light beam 2104 in a direction from the inside of the element to the outside (air).

Here, representing the incident angle of the light beam 2105 to the smooth surface 2301 with θ2 as shown in the figure and its refraction angle with θ2′ (not shown), the relational equation (Fresnel formulae) similar to the above Equation (5) holds among the incident angle θ2, the refraction angle θ2′, and an intensity reflectivity R2 of the light beam 2105 on the smooth surface 2301 when the light beam 2105 is a P-polarized light beam like the above light beam 2104. That is,

R2={tan [θ2−θ2′]/tan [θ2+θ2]}². (7)

Further, between the incident angle θ2 and the refraction angle θ2′, the following relational equation holds pursuant to the basic law of refraction like Equation (6). It should be noted that the right-hand side of the equation below differs from the right-hand side of the former Equation (6).

sin [θ2′]=n×sin [θ2]. (8)

Accordingly, as in the case of the above light beam 2104, using Equations (7) and (8), the intensity reflectivity R2 of the light beam 2105 incident on the smooth surface 2301 of the optical beam combiner 2103 can be determined using the incident angle θ2 and the refractive index n of the optical beam combiner 2103.

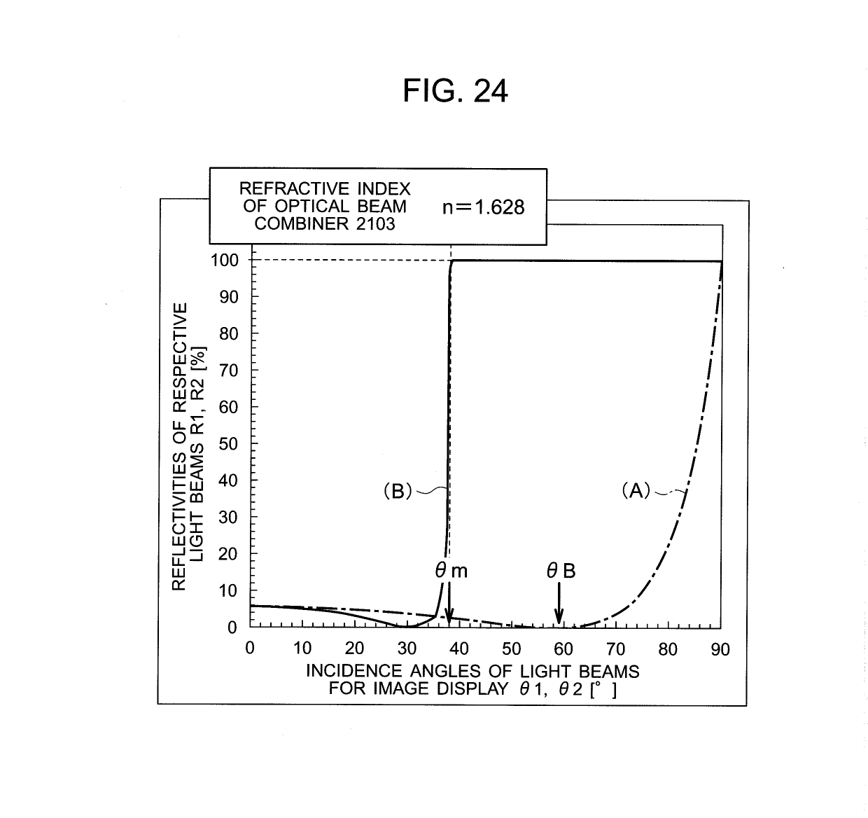

FIG. 24 is a graph of the relations between the incident angles θ1 and θ2 to the smooth surface 2301 and the intensity reflectivity R1 and R2 of the light beams 2104 and 2105, respectively, using above Equation (5) through Equation (8).

In graphical illustration, it is assumed that as an example of the glass material constituting the optical beam combiner 2103 an optical glass material represented by a code N-F2 (from an optical glass datasheet by SCHOTT Inc.), which is widely circulated as an optical glass material of a high refractive index, is used and as the value of its refractive index n, a value 1.628 for green light of the wavelength λ=510 nm band described in the datasheet is used for calculation.

In the figure, an alternate long and short dash line (A) shows the intensity reflectivity R1 of the light beam 2104 incident on the smooth surface 2301 and a solid line (B) shows the intensity reflectivity R2 of the light beam 2105 likewise incident on the smooth surface 2301.

First, looking at the alternate long and short dash line (A) in the figure, the intensity reflectivity R1 is nearly 0% near the incident angle θ1 of 60°. The intensity reflectivity R1 being nearly 0% means that the light beam 2104 transmits through the smooth surface 2301 of the optical beam combiner 2103 at a transmittance of nearly 100%. Such a physical phenomenon can be explained as below.

Now, let's look at the denominator of the right-hand side of the above Equation (5), tan [θ1+θ1′]. By resolving this expression,

tan [θ1+θ1′]=(tan [θ1]+tan [θ1′])/(1−tan [θ1]×tan [θ1′]). (9)

Then, when as the incident angle θ1 a predetermined angle θB which is defined as

tan [θB]=n (10)

is selected, for instance, a refraction angle θB′ for the incident angle θB is represented as seen in the following by derivation using the relation shown in Equation (6) and the like. Incidentally, detailed process of derivation is complicated and, therefore, omitted in the present specification.

tan [θB′]=1/n. (11)

By substituting the results of Equations (10) and (11) into the above Equation (9), the denominator of the right-hand side of Equation (9) becomes 0 and, eventually,

tan [θB+θB′]=∞. (12)

Then, by further substituting the result of Equation (12) into the right-hand side of Equation (5), the denominator becomes ∞ and, eventually, the right-hand side of Equation (5)=0.

Namely, when the incident angle θ1 is a predetermined angle θB which satisfies the above Equation (10), the intensity reflectivity R1 of the light beam 2104 becomes 0[%] theoretically, that is an intensity transmittance T1=100[%].

Incidentally, the predetermined angle θB satisfying the above Equation (10) is generally called the Brewster angle. For example, when the refractive index n of the optical beam combiner 2103 is set to be 1.628 as in the example of FIG. 24, its Brewster angle θ1 becomes about 58.5° and at the Brewster angle and angles near it the light beam 2104 has approximately 100% transmittance, so that it can transmit and propagate through the optical beam combiner 2103 with almost no loss of the energy (intensity) of the incident light beam.

Next, let's look at the solid line (B) in FIG. 24. As mentioned above, the line (B) graphically indicates the relation between the incident angle θ2 and the intensity reflectivity R2 of the light beam 2105 being incident on the smooth surface 2301 from the inside of the optical beam combiner 2103.

According to this graph, while the intensity reflectivity R2 of the light beam 2105 is about 10% or less up to the incident angle θ2 of around 36°, it increases rapidly, as θ2 goes beyond 36° and is almost completely 100% as it is equal to or exceeds 38°. Such a physical phenomenon can be explained as below.

That is, when in the above Equation (8) the incident angle θ2 is set to an angle equal to or greater than a predetermined angle θm which satisfies

sin [θm]=1/n (13)

from the relation shown in Equation (8) it becomes

sin [θ2′]>1, (14)

and the relation of Equation (8) per se cannot hold. It means that a light beam subject to transmission or refraction does not physically exist and as a result the entire of the light beam is reflected, thus establishing 100% reflectivity theoretically.

Incidentally, the predetermined angle θm satisfying the above Equation (13) in this manner is generally called a total reflection angle.

For example, when the refractive index n of the optical beam combiner 2103 is set to be 1.628 as in the example of FIG. 24, its total reflection angle θm becomes about 38°, and by setting the incident angle θ2 to 38° or more the light beam 2105 incident on the smooth surface 2301 can be reflected at 100% intensity reflectivity, namely without loosing the optical energy at all.

That is, by making use of the relations of the aforementioned Brewster angle and the total reflection angle, for the light beams caused to be incident on the single transparent smooth surface in opposite directions with each other, one can transmit at almost 100% transmittance and the other can be reflected at 100% reflectivity.

Speaking further, by optimally designing the refractive index n of the optical beam combiner including the smooth surface and the incident angles of the respective light beams with respect to it based on the aforementioned theories, the refraction angle of the transmitted and refracted light beam can be made approximately match the reflection angle of the reflected light beam and, eventually, with a simple structure and inexpensive optical element such as a glass prism, light beams can be combined or their optical paths can be deflected at extremely high optical utilization efficiencies.

For example, as in the case of the previously-described embodiment, using an optical prism of a triangle pole shape shown in FIG. 23 constructed of the optical glass material indicated by the code N-F2 (refractive index n=1.628) as the optical beam combiner 2103, when the light beam 2104 enters at the incident angle θ1 of 65°, its intensity reflectivity R1=0.9[%] can be obtained with calculation using the above Equations (5) and (6). Namely, this means that the light beam 2104 transmits, refracts, and progresses through the optical beam combiner 2103 at an extremely high transmittance of intensity transmittance T1=99.1[%].

At that time, the refraction angle θ1′ amounts to about 34° through calculation using Equation (6).

On the other hand, when the incident angle θ2 of the light beam 2105 onto the smooth surface 2301 is set to θ2=39°, since this is obviously in excess of the above total reflection angle θm=38°, its intensity reflectivity theoretically becomes 100%. Then, at that time the reflection angle naturally becomes 39°, which is equal to the incident angle.

As a result, the relative slant angle (aperture angle) β between the light beams 2104 and 2105 which progress within the optical beam combiner 2103 becomes 39°−34°=5°, which can satisfy the previously described laser safety condition, that is β>4°.

Incidentally, the two light beams for image display, which start as the light beams 2104 and 2105 and end up as the light beams 2106 and 2107, respectively, which exit from the optical beam combiner 2103, are subjected to be affected by refraction at the time when they transmit through the third smooth surface 2303 of the optical beam combiner 2103 as shown in FIG. 23 so that their relative slant angle (aperture angle) β deviates slightly from 5° to be exact; by optimally designing the angle of the smooth surface 2303 in such a manner that the two light beams incident on the smooth surface 2303 are incident at angles close to normal incidence with respect to the smooth surface 2303, the relative slant angle (aperture angle) β of the light beams 2106 and 2107 can be so designed as to be approximately 5° or more and 10° or less at most.

In the foregoing embodiment, an example in which the optical glass material indicated by the code N-F2 (refractive index n=1.628) which is generally circulated as a glass material having a high refractive index is used as the material constituting the optical beam combiner 2103 is introduced; optical glass materials or optical plastic materials having even higher refractive indexes exist and, since the degree of freedom of design can be extended by using those, further optimal design can be possible.

Also, it should be noted particularly herein that the aforementioned definition equation of the total reflection angle θm, Equation (13), does not depend on the polarization state of the light beam 2105.

More specifically, whenever the light beam 2105 has its incident angle θ2 equal to or greater than the total reflection angle θm expressed by Equation (13), the intensity reflectivity can be made to be 100% theoretically regardless of its polarization state being P-polarized same as for the light beam 2104, linearly polarized in the polarization direction normal to the plane of the paper different from P-polarized (hereinafter, this polarization state is referred to S-polarized), and, besides, in an arbitrary polarization state other than P-polarized or S-polarized. Regarding the light beam 2104, on the other hand, the Fresnel formulae shown as the above Equation (5) is essentially a valid equation based of the prerequisite of the polarization state of the incident light beam being P-polarized and there is a restriction of making it enter as P-polarized.

Therefore, when the optical beam combiner of the present invention is used, the polarization states of the light beams 2104 and 2105 to be combined with each other can be unified to the P-polarized or, alternatively, the light beam 2104 can be set as P-polarized and the light beam 2105 can be set as S-polarized, thus setting them to mutually perpendicular polarization states.

This increases the degree of freedom of optics design when the scanning projection apparatus and the scanning image display are designed, that is extremely useful.

On the other hand, attention is to be paid to the fact that, as described while explaining the embodiment of FIG. 21, whereas the light beams 2106 and 2107 exiting from the optical beam combiner 2103 are structured to be incident on the reflection mirror in the scan mirror device 2101 for optical beam scanning, it is preferable that they should be so designed that the two light beams are incident on a prescribed point as close to its scan rotation axis as possible in the actual apparatus at that moment.

To implement this, in consideration of the fact that the light beams 2106 and 2107 make the prescribed relative slant angle (aperture angle) β, it needs to be so designed that the point of incidence of the light beam 2104 on the smooth surface 2301 is deviated by a predetermined amount in advance from the point of incidence of the light beam 2105 on the same smooth surface 2301 as shown in FIG. 23.

Incidentally, the optical beam combiner 2103 explained in connection with FIGS. 23 and 24 is structured as an optical prism of a triangle pole shape made of the optical glass material having a high refractive index (refractive index n=1.628) indicated by the code N-F2 as described previously but this is merely an embodiment of the optical beam combiner of the present invention and the present invention is not limited thereto.

Namely, it does not matter at all even if, as the optical material for forming the optical beam combiner, an optical glass material, a plastic material for optics use, or the like other than the high-refractive index optical glass material indicated by the code N-F2 is used.

Further, its shape is not limited to the form of a triangle pole either; as long as it is in a shape and a structure which satisfies the relations among the respective incident angles of a plurality of the light beams in the present invention described so far, it does not matter at all whatever the shape and the structure are.

Moreover, it does not matter at all even if, by combining the shapes and the structures satisfying the relations among the respective incident angles of a plurality of the light beams in the present invention described so far, it is so structured as to project three or more light beams for image display with a predetermined relative angle (aperture angle) β given therebetween onto the projection screen.

It should be further understood by those skilled in the art that although the foregoing description has been made on embodiments of the invention, the invention is not limited thereto and various changes and modifications may be made without departing from the spirit of the invention and the scope of the appended claims.

1. A scanning projection apparatus comprising:
a plurality of laser light sources;
optical means each of which converts an light beam emitted from each of the plurality of laser light sources into a substantially collimated light beam or a weakly converged light beam;
optical means which makes coincident with each other optical axes of the plurality of optical beams each converted into a substantially collimated light beam or a weakly converged light beam; and
an optical reflection and scan means which drives repetitive scan of the light beams of which optical axes are made coincident in directions of two axes substantially perpendicular to each other,
the scanning projection apparatus containing at least two or more light beams of which optical axes are made coincident and displaying a plurality of images on a projection screen by making the light beams of which optical axes are made coincident have predetermined relative angles therebetween so that the plurality of images are displayed with slight shifts of positions from each other.

2. The scanning projection apparatus according to claim 1, wherein the relative angles between the plurality of light beams which are emitted from the plurality of light sources and of which optical axes are made coincident are 4° or more.

3. The scanning projection apparatus according to claim 1, wherein a separation amount of the images in the plurality of images arranged with the shifts of positions from each other is ½ or less of a size of a image.

4. The scanning projection apparatus according to claim 1, wherein the plurality of light beams which are emitted from the plurality of light sources and of which optical axes are made coincident are substantially coincident with each other at a reflection area of the optical reflection and scan means which drives repetitive scan of the light beams of which optical axes are made coincident in directions of two axes substantially perpendicular to each other.

5. The scanning projection apparatus according to claim 1 further comprising an optical element from which a plurality of light beams each made coincident with each other the optical axes of the light beams emitted from the plurality of light sources exit at predetermined angles, wherein surfaces from which the plurality of beams exit form a convex shapes with each other.

6. The scanning projection apparatus according to claim 1 further comprising an optical element from which a plurality of light beams each made coincident with each other the optical axes of the light beams emitted from the plurality of light sources exit at predetermined angles, wherein surfaces from which the plurality of beams exit form a concave shape with each other.

7. The scanning projection apparatus according to claim 1 further comprising an optical element from which a plurality of light beams each made coincident with each other the optical axes of the light beams emitted from the plurality of light sources exit at predetermined angles, wherein surfaces from which the plurality of beams exit form a concave shape with each other, and surfaces which the plurality of beams enter form a convex shape with each other.

8. The scanning projection apparatus according to claim 1 further comprising an optical element from which a plurality of light beams each made coincident with each other the optical axes of the light beams emitted from the plurality of light sources exit at predetermined angles, wherein the optical element let the plurality of light beams exit at the predetermined angles by reflecting light beams entering the element a plurality of times.

9. The scanning projection apparatus according to claim 8, wherein in the optical element from which the plurality of light beams each made coincident with each other the optical axes of the light beams emitted from the plurality of light sources exit at predetermined angles light beams entering the optical element are incident perpendicular with respect to an incident end surface.

10. The scanning projection apparatus according to claim 8, wherein in the optical element from which the plurality of light beams each made coincident with each other the optical axes of the light beams emitted from the plurality of light sources exit at predetermined angles, light beams exiting from the optical element exit perpendicular with respect to an exit end surface.

11. The canning projection apparatus according to claim 8, wherein in the optical element from which the plurality of light beams each made coincident with each other the optical axes of the light beams emitted from the plurality of light sources exit at predetermined angles, at least one of reflection surfaces of the optical element lets part of the incident light beams transmit therethrough.

12. A scanning image display with a scanning projection apparatus, comprising:
the scanning projection apparatus according to claim 1;
a laser light source driving circuit which drives the plurality of laser light sources;
a scan mirror driving circuit which supplies a driving signal to a scan mirror of the optical reflection and scan means so as to repetitively rotate the mirror surface two-dimensionally; and
a video signal processing circuit which transmits respective RGB signals to the laser light source driving circuit and the scan mirror driving circuit.

13. The scanning projection apparatus according to claim 1, wherein light beams emitted from a plurality of RGB light sources are substantially collimated.

14. The scanning projection apparatus according to claim 1, wherein light beams emitted from a plurality of RGB light sources are substantially perpendicular with each other.

15. The scanning projection apparatus according to claim 1, wherein a plurality of RGB light sources are so arranged to oppose to each other.

16. The scanning projection apparatus according to claim 1, wherein a light beam scanning means is arranged at a position opposite to a direction in which light beams emit from a plurality of RGB light sources.

17. The scanning projection apparatus according to claim 1,
wherein the optical beam combiner comprises an optical glass or a transparent plastic for optics having a predetermined refractive index (n) and at least one smooth surface;
wherein a first light beam for image display emitted from a first light source of the two or more light sources is incident on the smooth surface of the optical beam combiner in a direction from an outside thereof towards an inside of the optical beam combiner at an incident angle (θ1) with respect to the smooth surface where it satisfies Equation (1) below,
θ1≈ TAN⁻¹[n] (1);
and
wherein a second light beam for image display emitted from a second light source is incident on the smooth surface of the optical beam combiner in a direction from an inside of the optical beam combiner to an outside of the combiner at an incident angle (θ2) with respect to the smooth surface where it satisfies a relational Equation (2) below,
θ2>SIN⁻¹[1/n] (2).

18. The scanning projection apparatus according to claim 17, wherein the first light beam for image display is a light beam linearly polarized in substantially parallel to a plane formed by a center optical axis of the first light beam for image display and a plane-normal to the smooth surface.

19. The scanning projection apparatus according to claim 17, wherein the optical beam combiner comprises an optical glass material or a transparent plastic material for optics having a refractive index of 1.60 or higher for a wavelength of visible light.

20. The scanning projection apparatus according to claim 17,
wherein the optical beam combiner comprises an optical glass material or a transparent plastic material for optics having a refractive index of 1.60 to 1.65 for a wavelength of visible light;
wherein the incident angle (θ1) of the first light beam for image display is set to a predetermined angle within an angle range of 60°±10°; and
wherein the incident angle (θ2) of the second light beam for image display is set to a predetermined angle within an angle range of 43°±5°.
